(19) United States
(12) Patent Application Publication
(10) Pub. No.: US 2026/0281432 A1
(43) Pub. Date: Sep. 17, 2026

(54) INFORMATION PROCESSING DEVICE AND METHOD

(71) Applicant: Sony Group Corporation, Tokyo (JP)

(72) Inventors: Koji YANO, Tokyo (JP); Ohji NAKAGAMI, Tokyo (JP); Satoru KUMA, Tokyo (JP)

(73) Assignee: Sony Group Corporation, Tokyo (JP)

(21) Appl. No.: 18/878,074

(22) PCT Filed: Jul. 20, 2023
(86) PCT No.: PCT/JP2023/026534

§ 371 Date: Dec. 23, 2024

(30) Foreign Application Priority Data
Aug. 1, 2022 (JP) 2022-122721

(51) Int. Cl. H04N 19/597; H04N 19/136; H04N 19/42; H04N 19/593; H04N 19/96

(52) U.S. Cl. CPC H04N 19/597; H04N 19/136; H04N 19/42; H04N 19/593; H04N 19/96

(57) ABSTRACT

There is provided an information processing device and method that make it possible to suppress deterioration in encoding efficiency. A normal vector serving as an attribute corresponding to a 3D data processing target geometry is predicted on the basis of information other than the normal vector, a prediction value of the normal vector is derived, a prediction residual that is a difference between the normal vector and the prediction value corresponding to the processing target geometry is generated, and the prediction residual of the normal vector corresponding to the processing target geometry is encoded. The present disclosure may be applied to, for example, an information processing device, an electronic apparatus, an information processing method, a program or the like.

### TECHNICAL FIELD

The present disclosure relates to an information processing device and method, and more particularly, to an information processing device and method that make it possible to suppress deterioration in encoding efficiency.

### BACKGROUND ART

Conventionally, it has been possible to use a normal vector as an attribute of a point cloud that is 3D data representing a three-dimensional structure (for example, see Non-Patent Literature 1).

### CITATION LIST

### Non-Patent Literature

Non-Patent Literature 1: “Information technology. Coded representation of immersive media. Part 9: Geometry-based point cloud compression”, ISO/IEC FDIS 23090-9:2022 (E), w19617_d23

### DISCLOSURE OF INVENTION

### Technical Problem

However, algorithms for encoding an attribute optimized for a normal vector have not been disclosed. Therefore, in a case of applying the normal vector as the attribute, there is a possibility of deteriorating encoding efficiency.

The present technology is made in view of the above described situation, and it is intended to suppress deterioration in encoding efficiency.

### Solution to Problem

An information processing device according to an aspect of the present technology includes: a normal vector prediction section configured to predict a yet-to-be-encoded normal vector of an encoding target point on the basis of encoded information different from the yet-to-be-encoded normal vector obtained through an encoding process of point cloud data, and derive a prediction value of the yet-to-be-encoded normal vector, in the encoding process; a prediction residual generation section configured to generate a prediction residual that is a difference between the prediction value and the yet-to-be-encoded normal vector; and a prediction residual encoding section configured to encode the prediction residual.

An information processing method according to the aspect of the present technology includes: predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; generating a prediction residual that is a difference between the prediction value and the yet-to-be-encoded normal vector; and encoding the prediction residual.

An information processing device according to another aspect of the present technology includes: a normal vector prediction section configured to predict a yet-to-be-encoded normal vector of an encoding target point on the basis of encoded information different from the yet-to-be-encoded normal vector obtained through an encoding process of point cloud data, and derive a prediction value of the yet-to-be-encoded normal vector, in the encoding process; and a normal vector decoding section configured to derive the yet-to-be-encoded normal vector by decoding a prediction residual that has been encoded and adding the prediction value to the prediction residual.

An information processing method according to the other aspect of the present technology includes: predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; and deriving the yet-to-be-encoded normal vector by decoding a prediction residual that has been encoded and adding the prediction value to the prediction residual.

The information processing device and method according to the aspect of the present technology includes: predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; generating a prediction residual that is a difference between the prediction value and the yet-to-be-encoded normal vector; and encoding the prediction residual.

The information processing device and method according to the other aspect of the present technology includes: predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; and deriving the yet-to-be-encoded normal vector by decoding a prediction residual that has been encoded and adding the prediction value to the prediction residual.

### BRIEF DESCRIPTION OF DRAWINGS

FIG. 1 is a diagram illustrating an example of a method of using normal vectors.

FIG. 2 FIG. 1 is a diagram for describing methods of encoding normal vectors.

FIG. 3 is a diagram for describing a prediction residual of a normal vector.

FIG. 4 is a block diagram illustrating a main functional configuration example of an encoding device.

FIG. 5 is a flowchart for describing an example of the flow of an encoding process.

FIG. 6 is a block diagram illustrating a main functional configuration example of a decoding device.

FIG. 7 is a flowchart for describing an example of the flow of a decoding process.

FIG. 8 is a diagram for describing trisoup.

FIG. 9 is a block diagram illustrating a main functional configuration example of an encoding device.

FIG. 10 is a flowchart for describing an example of the flow of an encoding process.

FIG. 11 is a block diagram illustrating a main functional configuration example of a decoding device.

FIG. 12 is a flowchart for describing an example of the flow of a decoding process.

FIG. 13 is a block diagram illustrating a main functional configuration example of an encoding device.

FIG. 14 is a flowchart for describing an example of the flow of an encoding process.

FIG. 15 is a block diagram illustrating a main functional configuration example of a decoding device.

FIG. 16 is a flowchart for describing an example of the flow of a decoding process.

FIG. 17 is a block diagram illustrating a main functional configuration example of an encoding device.

FIG. 18 is a flowchart for describing an example of the flow of an encoding process.

FIG. 19 is a flowchart for describing an example of the flow of a geometry encoding process.

FIG. 20 is a flowchart for describing an example of the flow of an attribute encoding process.

FIG. 21 is a flowchart for describing an example of the flow of a normal vector encoding process.

FIG. 22 is a block diagram illustrating a main functional configuration example of a decoding device.

FIG. 23 is a flowchart for describing an example of the flow of a decoding process.

FIG. 24 is a flowchart for describing an example of the flow of a geometry decoding process.

FIG. 25 is a flowchart for describing an example of the flow of an attribute decoding process.

FIG. 26 is a flowchart for describing an example of the flow of a normal vector decoding process.

FIG. 27 is a block diagram illustrating a main functional configuration example of a computer.

### MODE(S) FOR CARRYING OUT THE INVENTION

Hereinafter, modes for carrying out the present disclosure (hereafter, referred to as “embodiments”) will be described. Note that, the description will be given in the following order.
1. Documents etc. supporting technical contents and terms
2. Normal vector in GPCC
3. Predictive encoding of normal vector
4. Supplementary notes

### 1. Documents Etc. Supporting Technical Contents and Terms

The scope disclosed in the present technology is not limited to the content described in the embodiments and also includes the content described in the following Non-Patent Literature and the like that were known at the time of filing, the content of other literature referred to in the following Non-Patent Literature, and the like.

### Non-Patent Literature 1 (Aforementioned)

In other words, the content described in the Non-Patent Literature described above, content of other literature referred to in the Non-Patent Literature described above, and the like are also grounds for determining a support requirement.

### 2. Normal Vector in GPCC

### <Point Cloud>

Conventionally, as 3D data representing three-dimensional structures of stereo structural objects (objects having three-dimensional shapes), there have been point clouds that represent the objects as a set of multiple points. Data of the point cloud (also referred to as point cloud data) includes geometries (positional information) and attributes (attribute information) of respective points constituting the point cloud. The geometry indicates a position (coordinates) of the point in a three-dimensional space. The attribute indicates an attribute of the point. The attribute may include any information. For example, the attribute may include color information, reflectance information, normal vector, and the like of the respective points. As described above, such a point cloud has a relatively simple data structure, and makes it possible to represent any stereo structural object with sufficient accuracy by using sufficiently many dots.

### <GPCC>

However, such a point cloud has a relatively large data amount. Therefore, compression of the data amount through encoding or the like has been desired. Accordingly, for example, geometry-based point cloud compression (GPCC) described in Non-Patent Literature 1 has been considered. Non-Patent Literature 1 discloses encoding methods such as region-adaptive hierarchical transform (“RAHT”) or lifting, as methods of encoding attributes in the GPCC.

In addition, in the GPCC, application of normal vectors as attributes is allowed, and Non-Patent Literature 1 discloses a flag indicating that the attribute is the normal vector.

### <Use of Normal Vector>

In recent years, demands for such normal vectors have been increasing. For example, in computer graphics (CG), use of normal vector maps (normal maps) or bump mapping has been considered to render bumps and dips beyond information that the geometry has (for example, see https://docs.unity3d.com/ja/2018.4/Manual/StandardShade rMaterialParameterNormalMap.html). As described above, the point cloud may also have normal vectors as attributes of respective points. Therefore, in a way similar to the case of CG, it is possible to perform rendering with higher accuracy by using the normal vectors.

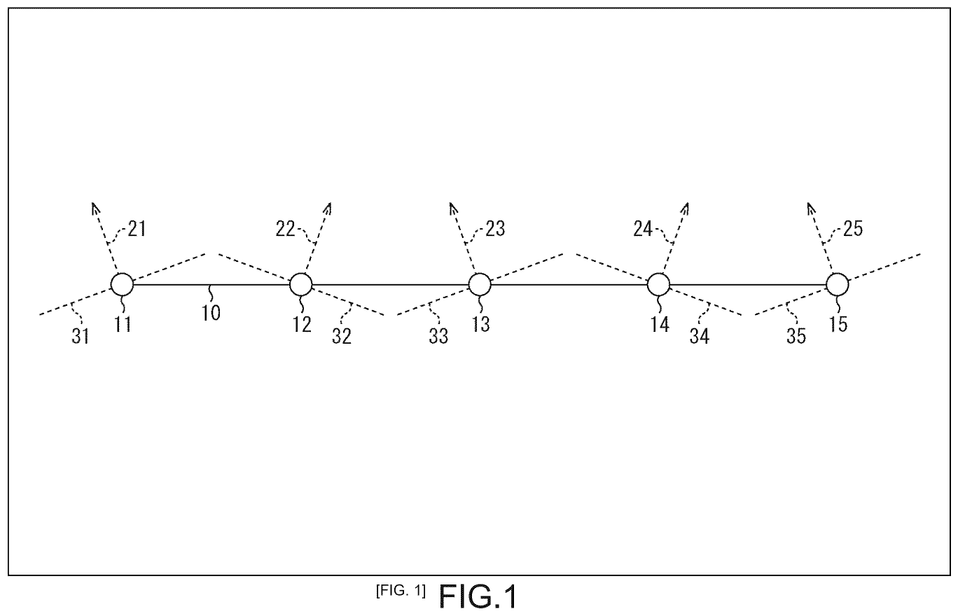

For example, as illustrated in FIG. 1, it is assumed that points 11 to 15 exist as a point cloud in a three-dimensional space. By performing rendering on the basis of geometries (coordinates) of them, a surface 10 indicated by a solid line is obtained. In other words, the surface 10 including the points 11 to 15 is represented as a plane. On the contrary, surfaces 31 to 35 indicated by dotted lines are obtained by respectively adding normal vectors 21 to 25 to the points 11 to 15 as attributes and performing rendering using these normal vectors. In other words, the surface including the points 11 to 15 is represented as a surface with bumps and dips. As described above, by performing rendering using normal vectors, it is possible to represent a surface with higher accuracy than a surface obtained from only the geometries.

In addition, algorithms that use normal vectors to create a mesh from a point cloud have also been considered (for example, see https://hhoppe.com/proj/poissonrecon/and https://mocobt.hatenablog.com/entry/2019/12/28/201236).

### <Derivation of Normal Vector>

There are various methods of deriving a normal vector. For example, there have been methods of acquiring normals of an object through sensing using a polarizing filter (for example, see https://www.sony.co.jp/Products/ISP/products/model/pc/i ntroduction01.html). In addition, there have been methods of estimating normal vectors from reflection intensity of light, reflectance from an object, or a difference from surroundings by using a sensor such as a laser scanner (for example, see https://ja.wikipedia.org/wiki/ [symbol] and https://ieeexplore.ieee.org/document/6225224).

### <Encoding of Normal Vector>

However, algorithms for encoding an attribute optimized for a normal vector have not been disclosed. For example, in a case of color information, a mode of utilizing correlation between U and V of YUV or the like is prepared. However, such a highly efficient mode is not prepared for normal vectors.

The normal vector has values in xyz directions with floating-point (Float) precision, and therefore has a larger amount of bits (for example, 32 bits) than other attributes. For example, the color information is 16 bits or 24 bits in general. In addition, the reflectance is about 10 bits in general.

Therefore, in a case of applying the normal vector as an attribute, there is a possibility of deteriorating encoding efficiency.

### 3. Predictive Encoding of Normal Vector

### <Method 1>

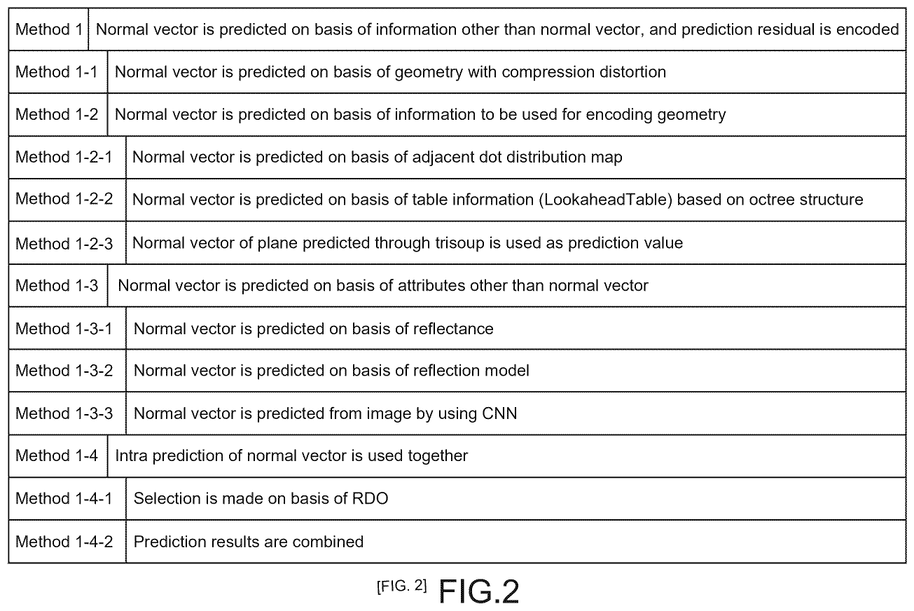

Therefore, as illustrated in a top row of a table in FIG. 2, a normal vector is predicted on the basis of encoded information other than the normal vector, and a prediction residual is encoded (method 1). The encoded information according to the present disclosure is information different from a normal vector before an encoding process (in other words, yet-to-be-encoded normal vector), and may be considered as information obtained through the encoding process. The information obtained through the encoding process includes information obtained during performing the encoding process as will be described later. Hereinafter, sometimes the “encoded information other than the normal vector” may be referred to as “information other than the normal vector”. In addition, sometimes the “yet-to-be-encoded normal vector” to be predicted may be simply referred to as a “normal vector”.

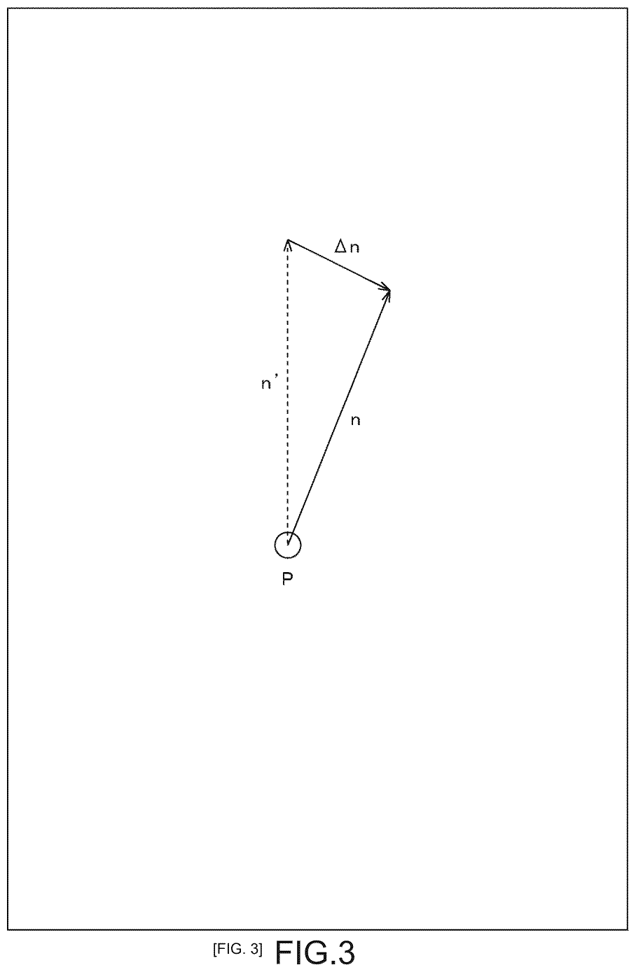

For example, as illustrated in FIG. 3, it is assumed that a normal vector n indicated by a solid arrow is set as an attribute of a point P. In this case, a prediction value (prediction vector n′) of the normal vector n indicated by a dotted arrow is derived, a difference (prediction residual Δn) of these vectors is derived, and then the prediction residual Δn is encoded. If the prediction vector n′ has sufficiently high prediction accuracy, the prediction residual Δn becomes small. Therefore, in a case of encoding the prediction residual Δn, it is possible to improve encoding efficiency more than a case of encoding the normal vector n. In other words, by applying the method 1, it is possible to suppress deterioration in encoding efficiency.

For example, an information processing device may include: a normal vector prediction section configured to predict a yet-to-be-encoded normal vector of an encoding target point on the basis of encoded information different from the yet-to-be-encoded normal vector obtained through an encoding process of point cloud data, and derive a prediction value of the yet-to-be-encoded normal vector, in the encoding process; a prediction residual generation section configured to generate a prediction residual that is a difference between the prediction value and the yet-to-be-encoded normal vector; and a prediction residual encoding section configured to encode the prediction residual.

In addition, an information processing method may include: predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; generating a prediction residual that is a difference between the prediction value and the yet-to-be-encoded normal vector; and encoding the prediction residual.

In addition, n information processing device may include: a normal vector prediction section configured to predict a yet-to-be-encoded normal vector of an encoding target point on the basis of encoded information different from the yet-to-be-encoded normal vector obtained through an encoding process of point cloud data, and derive a prediction value of the yet-to-be-encoded normal vector, in the encoding process; and a normal vector decoding section configured to derive the yet-to-be-encoded normal vector by decoding a prediction residual that has been encoded and adding the prediction value to the prediction residual.

In addition, an information processing method may include: predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; and deriving the yet-to-be-encoded normal vector by decoding a prediction residual that has been encoded and adding the prediction value to the prediction residual.

By doing so, it is possible to suppress deterioration in encoding efficiency as described above.

### <Method 1-1>

Any information can be used as the “information other than the normal vector” to predict the normal vector. For example, a geometry with compression distortion can be used. In other words, in a case where the above-described method 1 is applied, a normal vector may be predicted on the basis of the geometry with compression distortion as illustrated in a second row from the top of the table in FIG. 2 (method 1-1). In other words, it is possible to generate the geometry with compression distortion by encoding and decoding the geometry, and predict the normal vector on the basis of the geometry with compression distortion.

For example, the above-described information processing device including the normal vector prediction section, the prediction residual generation section, and the prediction residual encoding section may further include: a geometry encoding section configured to encode a geometry of the point cloud data as encoded information; and a geometry decoding section configured to decode encoded data of the geometry. The normal vector prediction section may derive a prediction value on the basis of the geometry obtained by decoding its encoded data (in other words, geometry with compression distortion). Sometimes the “encoded data of the geometry” according to the present disclosure may be simply referred to as an “encoded geometry” or a “geometry that has been encoded”.

In addition, for example, the above-described information processing device including the normal vector prediction section and the normal vector decoding section may further include a geometry decoding section configured to decode the geometry of the point cloud data that has been encoded as the encoded information. In this case, the normal vector prediction section may derive a prediction value on the basis of the geometry that has been decoded (in other words, geometry with compression distortion).

As described above, the geometry with compression distortion is obtained by encoding and decoding the geometry. Therefore, it is also easy for a decoding-side device to obtain it. In addition, as will be described later, it is possible to predict normal vectors at respective points on the basis of the geometries. In addition, it is possible to perform the prediction with sufficiently high prediction accuracy. Accordingly, by applying the method 1-1, it is possible to suppress deterioration in encoding efficiency.

### <Encoding Device>

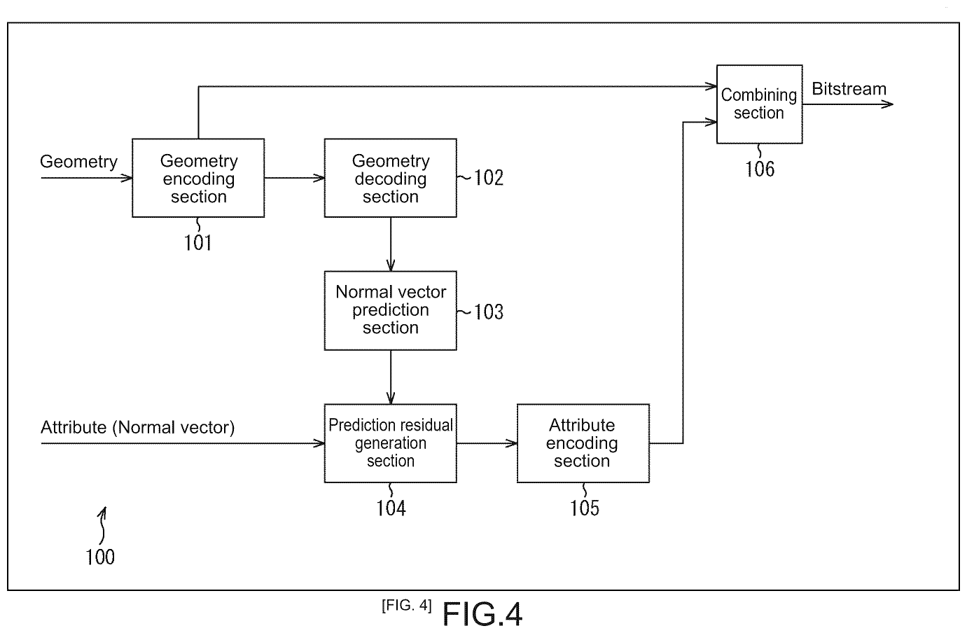

FIG. 4 is a block diagram illustrating an example of a configuration of an encoding device as an aspect of an information processing device to which the present technology is applied. An encoding device 100 illustrated in FIG. 4 is a device that encodes a point cloud. The encoding device 100 encodes a point cloud through the GPCC described in Non-Patent Literature 1. In addition, the encoding device 100 applies the above-described method 1-1 to encode a normal vector that is an attribute of the point cloud.

Note that, FIG. 4 merely illustrates principal ones among processing sections, data flows, and the like, and does not illustrate all of them. That is, with regard to the encoding device 100, there may be a processing section not illustrated as a block in FIG. 4, or there may be a flow of processing or data not illustrated as an arrow or the like in FIG. 4.

As illustrated in FIG. 4, the encoding device 100 includes a geometry encoding section 101, a geometry decoding section 102, a normal vector prediction section 103, a prediction residual generation section 104, an attribute encoding section 105, and a combining section 106.

The geometry encoding section 101 acquires geometries of a point cloud supplied to the encoding device 100, encodes the geometries as encoded information, and generates encoded data of the geometries. Any method can be used as the method of encoding the geometries. For example, the geometry encoding section 101 may encode geometries through a method including arithmetic encoding. For example, the geometry encoding section 101 may apply the method described in Non-Patent Literature 1. The geometry encoding section 101 supplies the generated encoded data of the geometries to the combining section 106. In addition, the geometry encoding section 101 supplies the generated encoded data of the geometries to the geometry decoding section 102.

The geometry decoding section 102 acquires the encoded data supplied from the geometry encoding section 101, decodes the encoded data, and generates (restores) the geometries. Any decoding method can be used as a method of decoding the encoded data as long as the method is compatible with the encoding method applied by the geometry encoding section 101. For example, the geometry decoding section 102 may decode the encoded data through a method including arithmetic decoding. For example, the geometry decoding section 102 may apply the method described in Non-Patent Literature 1. Note that, the generated (restored) geometries have compression distortion. The geometry decoding section 102 supplies the generated geometries (geometries with compression distortion) to the normal vector prediction section 103.

Note that, a purpose of the decoding of the encoded data of geometries by the geometry decoding section 102 is to generate the geometries with compression distortion. Therefore, reversible arithmetic encoding/arithmetic decoding may be omitted with regard to the encoded data to be processed by the geometry decoding section 102. In other words, it is also possible for the geometry encoding section 101 to supply data before the arithmetic encoding to the geometry decoding section 102. In this case, the geometry decoding section 102 may use the data (without performing the arithmetic decoding) to generate geometries with compression distortion.

The normal vector prediction section 103 acquires the geometries (geometries with compression distortion) supplied from the geometry decoding section 102, predicts normal vectors (yet-to-be-encoded normal vectors of encoding target points) by using the geometries, and derives prediction values (prediction vectors) of the normal vectors (yet-to-be-encoded normal vectors). The normal vector prediction section 103 supplies the derived prediction values to the prediction residual generation section 104.

Any method can be used as the method of predicting the normal vectors by using the geometries. For example, the normal vector prediction section 103 may apply a method described in https://recruit.cct-inc.co.jp/tecblog/img-processor/normal-estimation/. In a case of using this method, a search for K number of points adjacent to a certain point A (encoding target point) is performed first with regard to the point A that is a target of the encoding process. Next, a plane is estimated through a least-squares method using the geometries (coordinates) of K number of points that have been found. Next, a normal vector of the estimated plane is derived, and the derived normal vector is considered as a prediction value. Such an algorithm has been utilized in various situations, and it has already been demonstrated that such an algorithm can obtain highly accurate prediction values.

The prediction residual generation section 104 acquires normal vectors (yet-to-be-encoded normal vectors of encoding target points) as attributes of the point cloud to be supplied to the encoding device 100. The prediction residual generation section 104 also acquires the prediction values supplied from the normal vector prediction section 103. Next, the prediction residual generation section 104 derives differences (prediction residuals) between a prediction value and a normal vector corresponding to the respective points (geometries). In other words, the prediction residual generation section 104 subtracts the prediction values corresponding to the respective normal vectors from the respective normal vectors that have been acquired, and derives respective prediction residuals. The prediction residual generation section 104 supplies the generated prediction residuals to the attribute encoding section 105.

The attribute encoding section 105 acquires the prediction residuals of the normal vectors supplied from the prediction residual generation section 104, encode the prediction residuals, and generates encoded data of ((prediction residuals of) normal vectors serving as) attributes. Therefore, the attribute encoding section 105 can also be said as a normal vector encoding section or prediction residual encoding section. Any method can be used as the method of encoding the prediction residuals. For example, the attribute encoding section 105 may encode the prediction residuals through a method including arithmetic encoding. The attribute encoding section 105 supplies the generated encoded data of the attributes to the combining section 106.

The combining section 106 acquires the encoded data of the geometries supplied from the geometry encoding section 101. The combining section 106 also acquires encoded data of the attributes supplied from the attribute encoding section 105 (encoded data of prediction residuals of normal vectors). The combining section 106 generates encoded data (bitstream) of the point cloud including both the acquired encoded data of the geometries and the acquired encoded data of the attributes. The combining section 106 outputs the generated bitstream to an outside of the encoding device 100. For example, the bitstream may be stored in any storage medium or may be transmitted to another device (for example, decoding device) via any communication medium.

The encoding device 100 including such structural elements makes it possible to predict the normal vectors with sufficiently high prediction accuracy on the basis of the geometries with compression distortion. Accordingly, the encoding device 100 makes it possible to suppress deterioration in efficiency of encoding ((normal vectors serving as) attributes of) a point cloud.

### <Flow of Encoding Process>

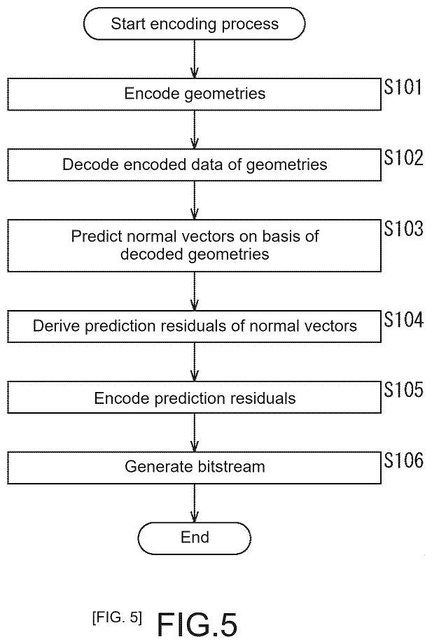

With reference to a flowchart illustrated in FIG. 5, an example of a flow of the encoding process executed by the encoding device 100 will be described.

When the encoding process starts, the geometry encoding section 101 of the encoding device 100 encodes geometries in Step S101.

In Step S102, the geometry decoding section 102 decodes encoded data of the geometries generated in Step S101.

In Step S103, the normal vector prediction section 103 predicts normal vectors on the basis of the geometries (geometries with compression distortion) obtained through the decoding in Step S102, and derives prediction values of the normal vectors.

In Step S104, the prediction residual generation section 104 subtracts, from the respective normal vectors, the prediction values corresponding to the respective normal vectors derived in Step S103, and derives respective prediction residuals of the normal vectors.

In Step S105, the attribute encoding section 105 encodes the prediction residuals derived in Step S104.

In Step S106, the combining section 106 combines the encoded data of the geometries generated in Step S101 and the encoded data of ((prediction residuals of) normal vectors serving as) the attributes generated in Step S105, and generates encoded data (bitstream) of a point cloud.

When the process in Step S106 ends, the encoding process ends.

By executing the above-described processes, the encoding device 100 makes it possible to predict the normal vectors with sufficiently high prediction accuracy on the basis of the geometries with compression distortion. Accordingly, the encoding device 100 makes it possible to suppress deterioration in efficiency of encoding ((normal vectors serving as) attributes of) the point cloud.

### <Decoding Device>

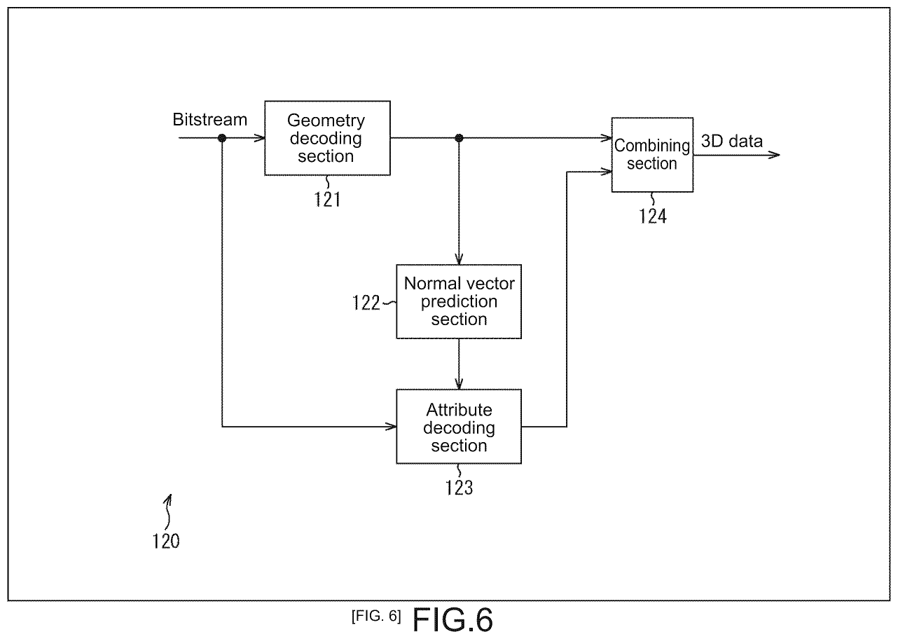

FIG. 6 is a block diagram illustrating an example of a configuration of a decoding device as an aspect of an information processing device to which the present technology is applied. A decoding device 120 illustrated in FIG. 6 is a device that decodes encoded data (bitstream) of a point cloud. The decoding device 120 decodes the bitstream through the GPCC described in Non-Patent Literature 1 to generate (restore) the point cloud. In addition, the decoding device 120 applies the above-described method 1-1 to decode the encoded data of ((prediction residuals of) normal vectors serving as) attributes of the point cloud. For example, the decoding device 120 decodes the bitstream generated by the encoding device 100 (FIG. 4).

Note that, FIG. 6 merely illustrates principal ones among processing sections, data flows, and the like, and does not illustrate all of them. That is, with regard to the decoding device 120, there may be a processing section not illustrated as a block in FIG. 6, or there may be a flow of processing or data not illustrated as an arrow or the like in FIG. 6.

As illustrated in FIG. 6, the decoding device 120 includes a geometry decoding section 121, a normal vector prediction section 122, an attribute decoding section 123, and a combining section 124.

The geometry decoding section 121 acquires a bitstream (encoded data of point cloud) supplied to the decoding device 120, decodes encoded data of geometries included in the bitstream, and generates (restores) the geometries. Any decoding method can be used as a method of decoding the geometries as long as the method is similar to the decoding method applied by the geometry decoding section 102 of the encoding device 100. For example, the geometry decoding section 121 may decode the encoded data through a method including arithmetic decoding. For example, the geometry decoding section 121 may apply the method described in Non-Patent Literature 1. Note that, the generated (restored) geometries have compression distortion. The geometry decoding section 121 supplies the geometries with compression distortion to the normal vector prediction section 122 and the combining section 124.

The normal vector prediction section 122 acquires the geometries (geometries with compression distortion) supplied from the geometry decoding section 121, predicts normal vectors by using the geometries, and derives prediction values (prediction vectors) of the normal vectors. The normal vector prediction section 122 supplies the derived prediction values to the attribute decoding section 123.

Any prediction method can be used as a method of predicting the normal vectors by using the geometries as long as the method is similar to the prediction method applied by the normal vector prediction section 103 of the encoding device 100. For example, the normal vector prediction section 122 may apply a method described in https://recruit.cct-inc.co.jp/tecblog/img-processor/normal-estimation/.

The attribute decoding section 123 acquires the bitstream (encoded data of point cloud) supplied to the decoding device 120, decodes the encoded data of ((prediction residuals of) normal vectors serving as) attributes included in the bitstream, and generates (restores) the ((prediction residuals of) normal vectors serving as) attributes. Any decoding method can be used as a method of decoding the encoded data as long as the method is compatible with the encoding method applied by the attribute encoding section 105 of the encoding device 100. For example, the attribute decoding section 123 may decode the encoded data through a method including arithmetic decoding.

The attribute decoding section 123 also acquires the prediction values of the normal vectors supplied from the normal vector prediction section 122. The attribute decoding section 123 derives the normal vectors by adding the prediction values corresponding to the prediction residuals to the generated (restored) prediction residuals of the normal vectors. The attribute decoding section 123 supplies the derived normal vectors to the combining section 124 as the attributes.

The combining section 124 acquires the geometries supplied from the geometry decoding section 121. The combining section 124 also acquires the attributes supplied from the attribute decoding section 123. The combining section 124 combines the acquired geometries and the acquired attributes to generate data (3D data) of the point cloud. The combining section 124 outputs the generated 3D data to an outside of the decoding device 120. For example, the 3D data may be stored in any storage medium or may be rendered and displayed on another device.

The decoding device 120 including such structural elements makes it possible to predict the normal vectors with sufficiently high prediction accuracy on the basis of the geometries with compression distortion. Accordingly, the decoding device 120 makes it possible to suppress deterioration in efficiency of encoding ((normal vectors serving as) attributes of) the point cloud.

### <Flow of Decoding Process>

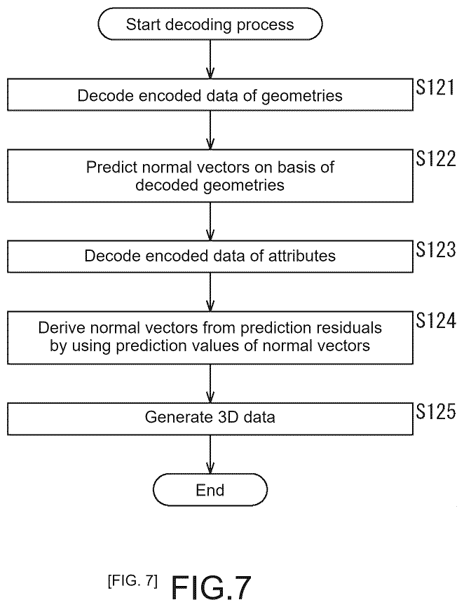

With reference to a flowchart illustrated in FIG. 7, an example of a flow of the decoding process executed by the decoding device 120 will be described. When the decoding process starts, the geometry decoding section 121 of the decoding device 120 decodes encoded data of geometries in Step S121.

In Step S122, the normal vector prediction section 122 predicts normal vectors on the basis of the geometries (geometries with compression distortion) obtained through the decoding in Step S121, and derives prediction values of the normal vectors.

In Step S123, the attribute decoding section 123 decodes encoded data of attributes and generates (restores) prediction residuals.

In Step S124, the attribute decoding section 123 adds the prediction values corresponding to the prediction residuals derived in Step S122 to the prediction residuals generated (restored) in Step S123, and derives the normal vectors.

In Step S125, the combining section 124 combines the geometries generated (restored) in Step S121 and the (normal vectors serving as) attributes derived in Step S124, and generates data (3D data) of a point cloud.

When the process in Step S125 ends, the decoding process ends.

By executing the above-described processes, the decoding device 120 makes it possible to predict the normal vectors with sufficiently high prediction accuracy on the basis of the geometries with compression distortion. Accordingly, the decoding device 120 makes it possible to suppress deterioration in efficiency of encoding ((normal vectors serving as) attributes of) the point cloud.

### <Method 1-2>

In addition, for example, information to be used for encoding (decoding) a geometry can be used as the “information other than the normal vector” to predict the normal vector. In other words, in a case where the above-described method 1 is applied, a normal vector may be predicted on the basis of the information to be used for encoding (decoding) a geometry as illustrated in a third row from the top of the table in FIG. 2 (method 1-2). In other words, it is possible to acquire information obtained through encoding (decoding) of the geometry and predict the normal vector on the basis of this information.

For example, the above-described information processing device including the normal vector prediction section, the prediction residual generation section, and the prediction residual encoding section may further include a geometry encoding section configured to encode the geometry of the point cloud data as the encoded information. In this case, the normal vector prediction section may derive a prediction value on the basis of encoded information to be used for encoding the geometry (for example, analysis of octree).

In addition, for example, the above-described information processing device including the normal vector prediction section and the normal vector decoding section may further include a geometry decoding section configured to decode the geometry of the point cloud data that has been encoded as the encoded information. In this case, the normal vector prediction section may derive a prediction value on the basis of information to be used for decoding the geometry (for example, analysis of octree).

For example, in the GPCC described in Non-Patent Literature 1 or the like, it is possible to obtain information that makes it possible to estimate normal vectors when encoding or decoding geometries. In the case of using the above-described method 1-1, a process with relatively large load such as adjacent point search is necessary to predict normal vectors from geometries with compression distortion. On the contrary, in the case of using the method 1-2, the normal vectors are predicted by using information obtained through encoding/decoding geometries. This makes it possible to omit the process with relatively large load such as the adjacent point search. Accordingly, it becomes possible to suppress increase in processing load due to encoding/decoding the normal vectors.

Note that, any information can be used as the “information to be used for encoding (decoding) a geometry”. Next, the following description will be given under the assumption that a result of analyzing an octree in an encoding process of point cloud data is used as the “information to be used for encoding (decoding) a geometry”.

### <Method 1-2-1>

For example, it may be possible to use map information (also referred to as adjacent dot distribution map) indicating distribution of adjacent points (that is, geometries of adjacent points). In other words, in a case where the above-described method 1-2 is applied, a normal vector may be predicted on the basis of the adjacent dot distribution map as illustrated in a fourth row from the top of the table in FIG. 2 (method 1-2-1). The map information according to the present disclosure may be considered as information indicating points (geometries) adjacent to an encoding target point in an octree structure.

For example, in the case where the information processing device includes the normal vector prediction section, the prediction residual generation section, the prediction residual encoding section, and the geometry encoding section, the normal vector prediction section may derive a prediction value on the basis of the map information indicating a point adjacent to the encoding target point in the octree structure. In addition, for example, in the case where the above-described information processing device includes the normal vector prediction section, the normal vector decoding section, and the geometry decoding section, the normal vector prediction section may derive a prediction value on the basis of the map information indicating a point adjacent to the encoding target point in the octree structure.

The adjacent dot distribution map explicitly indicates (geometries (coordinates) of) points adjacent to the encoding target point in the octree structure. This allows the normal vector prediction section to estimate a plane through the least-squares method using the geometries of the points indicated in the adjacent dot distribution map. In other words, it is possible for the normal vector prediction section to estimate planes around the encoding target point and derive their normal vectors without searching for its adjacent points.

### <Method 1-2-2>

In addition, table information (LookaheadTable) based on the octree structure of geometries can be used as the “information to be used for encoding (decoding) a geometry”. In other words, in a case where the above-described method 1-2 is applied, a normal vector may be predicted on the basis of the table information (LookaheadTable) based on the octree structure as illustrated in a fifth row from the top of the table in FIG. 2 (method 1-2-2).

For example, in the case where the information processing device includes the normal vector prediction section, the prediction residual generation section, the prediction residual encoding section, and the geometry encoding section, the normal vector prediction section may derive a prediction value on the basis of the table information based on the octree structure.

In addition, for example, in the case where the information processing device includes the normal vector prediction section, the normal vector decoding section, and the geometry decoding section, the normal vector prediction section may derive a prediction value on the basis of the table information based on the octree structure.

In the GPCC described in Non-Patent Literature 1, the geometries are quantized and transformed into pieces of data of respective voxels (also referred to as voxel data), the voxels are tree-structured and encoding is performed using the tree structure. The tree structure is referred to as the octree. This makes it possible to achieve scalability of the geometries (decoding at any level (resolution)). In other words, the geometries are encoded in an order corresponding to the octree structure as information of nodes of the octree. In the GPCC described in Non-Patent Literature 1, table information referred to as a look-ahead table (LookAheadTable) is used to manage nodes (geometries) adjacent to a processing target node in an order corresponding to its octree structure. In a way similar to the case of the adjacent dot distribution map, this allows the normal vector prediction section to estimate a plane through the least-squares method using geometries (coordinates) of points adjacent to the processing target point indicated in the look-ahead table. In other words, it is possible for the normal vector prediction section to estimate planes around the processing target point and derive their normal vectors without searching for its adjacent points.

### <Method 1-2-3>

In addition, planes predicted through trisoup can be used as the “information to be used for encoding (decoding) a geometry”. In other words, in a case where the above-described method 1-2 is applied, a normal vector of a plane predicted through the trisoup may be used as the prediction value as illustrated in a sixth row from the top of the table in FIG. 2 (method 1-2-3).

For example, in the case where the information processing device includes the normal vector prediction section, the prediction residual generation section, the prediction residual encoding section, and the geometry encoding section, the normal vector prediction section may set, as the prediction value, a normal of a triangular face of the geometry that has been encoded at a level of an octree having predetermined resolution, and the triangular face of the geometry may be a face to be subjected to a trisoup decoding process at a time of decoding.

In addition, for example, in the case where the information processing device includes the normal vector prediction section, the normal vector decoding section, and the geometry decoding section, the normal vector prediction section may set, as the prediction value, a normal of a triangular face of the geometry that has been encoded at a level of an octree having predetermined resolution, and the triangular face of the geometry may be a face to be subjected to the trisoup decoding process at a time of decoding.

For example, Ohji Nakagami, “PCC On Trisoup decode in G-PCC”, ISO/IEC JTC1/SC29/WG11 MPEG2018/m44706, October 2018, Macao, CN discloses a method called “trisoup” to represent points in a voxel as a triangular plane (triangular face). According to this method, the triangular face is formed in the voxel, and only coordinates of vertices of the triangular face are encoded under the assumption that all points in the voxel exist. Later, at a time of decoding, the respective points are restored on a triangular face derived from the coordinates of the vertices.

This makes it possible to represent the plurality of points in the voxel only by the (coordinates of vertices of) triangular face. In other words, for example, by applying the trisoup, it becomes possible to replace data of a predetermined intermediate resolution or lower in the octree with data of the trisoup (coordinates of vertices of triangular face). That is, there is no need to perform conversion into voxels until the highest resolution (leaves) in the octree. Accordingly, the amount of information can be reduced, and encoding efficiency can be improved.

In a case of applying the trisoup, points are restored on the triangular face at a time of decoding. For example, a triangular face is derived from decoded coordinates of vertices, a sufficient number of points are disposed arbitrarily on the triangular face, and some points are deleted in such a manner that the other points remain with a necessary resolution. By performing decoding with regard to respective voxels in such a manner, it is possible to restore a point cloud with desired resolution.

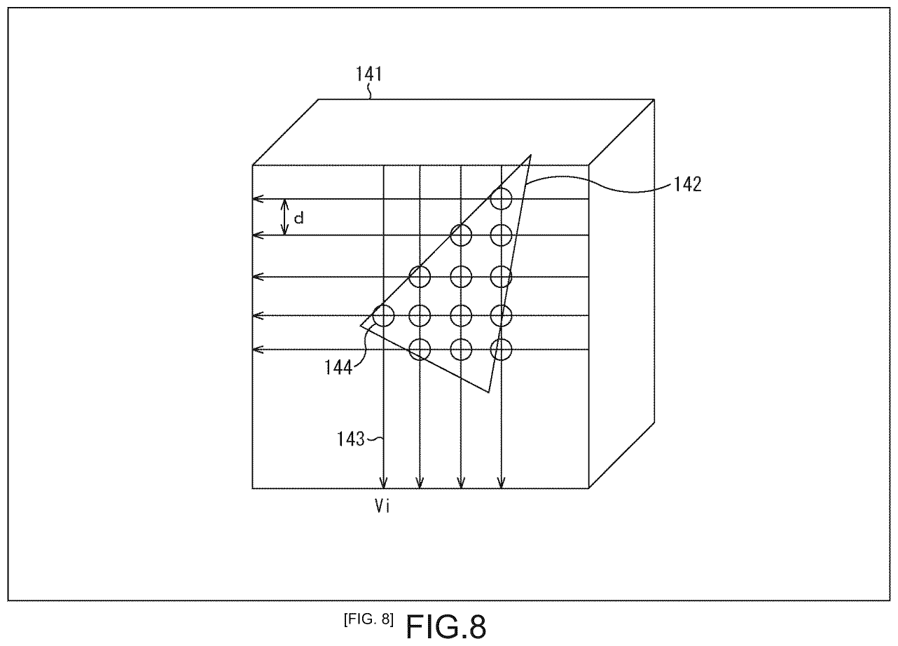

For example, as illustrated in FIG. 8, according to the above-described literature, a triangular face 22 that uses three points existing in a bounding box 141 as its vertices is derived from the bounding box 141 including encoding target data. Next, as indicated by an arrow 143, vectors Vi having a same direction and a same length as a side of the bounding box 141 is generated at intervals d. d represents a quantization size to be used at a time of transforming the bounding box 141 into voxels. In other words, the vectors Vi are set in such a manner that their start origins are position coordinates corresponding to a designated voxel resolution. Next, it is determined whether the vector Vi (the arrow 143) intersects with the decoded triangular face 142 (that is, triangular mesh). In a case where the vector Vi intersects with the triangular face 142, coordinate values of their intersection 144 is derived.

As described above, the triangular face is estimated in the case of applying the trisoup to encoding/decoding of geometries. More specifically, the normal vector prediction section sets, as the prediction value, a normal of the triangular face of the geometry to be subjected to the trisoup decoding process at a time of decoding. The triangular face is a face at a level of an octree having predetermined resolution. By utilizing the normal vector of the estimated triangular face (plane) as the prediction value, it is possible for the normal vector prediction section to derive the prediction value of the normal vector without searching for adjacent points.

For example, in a case of applying the trisoup, the octree of the geometries is not constructed until its deepest level (highest resolution). Therefore, in this case, the look-ahead table cannot be utilized to search for adjacent points at the highest resolution. In the case of applying the trisoup, the triangular face is estimated as described above. Therefore, by utilizing the triangular face, it is possible to easily obtain a prediction value of a normal vector corresponding to a geometry at the highest resolution.

### <Combination>

It is also possible to combine two or more among the methods 1-2-1 to 1-2-3. In other words, two or more among the above-described adjacent dot distribution map, look-ahead table, and plane predicted through the trisoup may be applied to prediction of normal vectors.

These methods are combined in any way. For example, methods may be selected from among the methods 1-2-1 to 1-2-3 under any condition, and normal vectors may be predicted by applying the selected methods. Alternatively, normal vectors may be predicted through the respective methods 1-2-1 to 1-2-3, prediction values obtained from the respective methods may be evaluated (by using a cost function or the like, for example), and an optimal prediction value may be selected on the basis of results of the evaluation. Alternatively, normal vectors may be predicted through two or more methods among the methods 1-2-1 to 1-2-3, and prediction values obtained through the respective methods may be combined, and a final prediction value (prediction value to be used for deriving prediction residual or normal vector) may be derived.

Alternatively, it is also possible to combine each of the methods 1-2-1 to 1-2-3 with another method. In other words, information such as the above-described adjacent dot distribution map, look-ahead table, and plane predicted through the trisoup may be combined with any other information and may be applied to prediction of normal vectors. In this case, a combination way similar to the above-described examples is used.

Alternatively, it is also possible to combine the method 1-1 with the method 1-2 (that may include the methods 1-2-1 to 1-2-3). In this case, a combination way similar to the above-described examples is used.

### <Encoding Device>

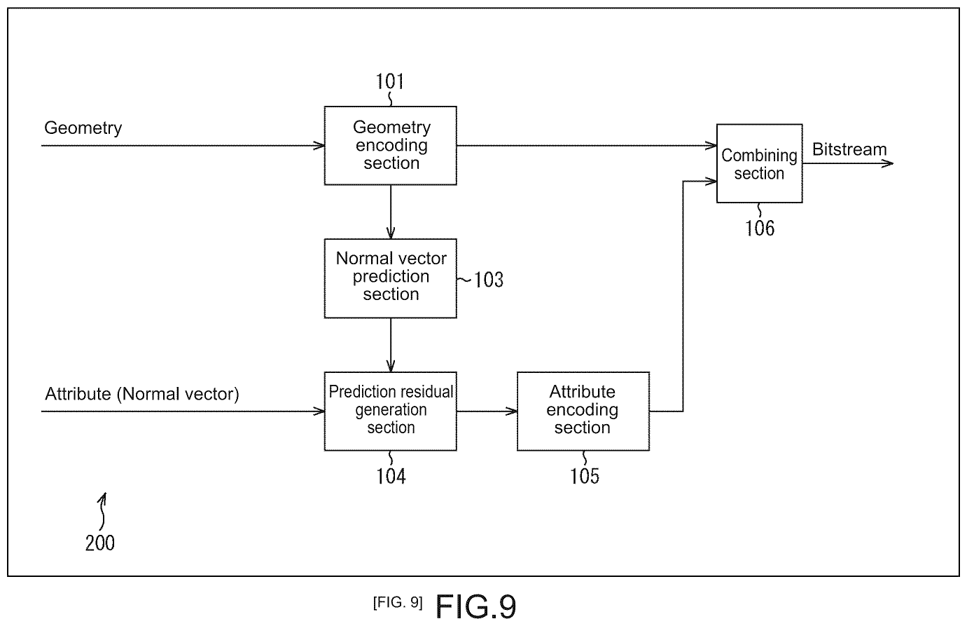

FIG. 9 is a block diagram illustrating an example of a configuration of an encoding device as an aspect of an information processing device to which the present technology is applied. An encoding device 200 illustrated in FIG. 9 is a device that encodes a point cloud. The encoding device 200 encodes a point cloud through the GPCC described in Non-Patent Literature 1. In addition, the encoding device 200 applies the above-described method 1-2 to encode a normal vector that is an attribute of the point cloud.

Note that, FIG. 9 merely illustrates principal ones among processing sections, data flows, and the like, and does not illustrate all of them. That is, with regard to the encoding device 200, there may be a processing section not illustrated as a block in FIG. 9, or there may be a flow of processing or data not illustrated as an arrow or the like in FIG. 9.

As illustrated in FIG. 9, the encoding device 200 includes the geometry encoding section 101, the normal vector prediction section 103, the prediction residual generation section 104, the attribute encoding section 105, and the combining section 106.

In a way similar to the case illustrated in FIG. 4, the geometry encoding section 101 acquires and encodes geometries and generates encoded data of the geometries. The geometry encoding section 101 supplies the generated encoded data of the geometries to the combining section 106. In addition, the geometry encoding section 101 supplies the normal vector prediction section 103 with information to be used for encoding the geometries (analysis of octree of geometries that has been encoded). Any information can be used as such information. For example, such information may be the adjacent dot distribution map, the look-ahead table, or the plane predicted through the trisoup.

The normal vector prediction section 103 acquires the information (information to be used for encoding the geometries) supplied from the geometry encoding section 101, predicts normal vectors by using the information, and derives prediction values (prediction vectors) of the normal vectors. The normal vector prediction section 103 supplies the derived prediction values to the prediction residual generation section 104.

Any method can be used as a method of predicting normal vectors on the basis of the information to be used for encoding geometries. For example, the normal vector prediction section 103 may apply the method 1-2-1 and derive the prediction values on the basis of map information (adjacent dot distribution map) indicating points adjacent to an encoding target point in the octree structure.

Alternatively, the normal vector prediction section 103 may apply the method 1-2-2 and derive the prediction values on the basis of table information (look-ahead table) based on the octree structure. Alternatively, the normal vector prediction section 103 may apply the method 1-2-3, and set, as the prediction value, a normal of a triangular face of the geometry that has been encoded at a level of an octree having predetermined resolution. The triangular face of the geometry may be a face to be subjected to the trisoup decoding process at a time of decoding. In any of these cases, planes are estimated by using the information to be used for encoding the geometries, and normal vectors of the planes are used as the prediction values. This makes it possible to obtain the prediction values with sufficiently high accuracy. Also, in any of these cases, the adjacent point search is not necessary unlike the method 1-1. This makes it possible to suppress increase in processing load due to predict normal vectors.

The prediction residual generation section 104, the attribute encoding section 105, and the combining section 106 execute their processes in ways similar to the case illustrated in FIG. 4.

The encoding device 200 including such structural elements makes it possible to predict the normal vectors with sufficiently high prediction accuracy on the basis of the information to be used for encoding the geometries. Accordingly, the encoding device 200 makes it possible to suppress deterioration in efficiency of encoding ((normal vectors serving as) attributes of) the point cloud.

### <Flow of Encoding Process>

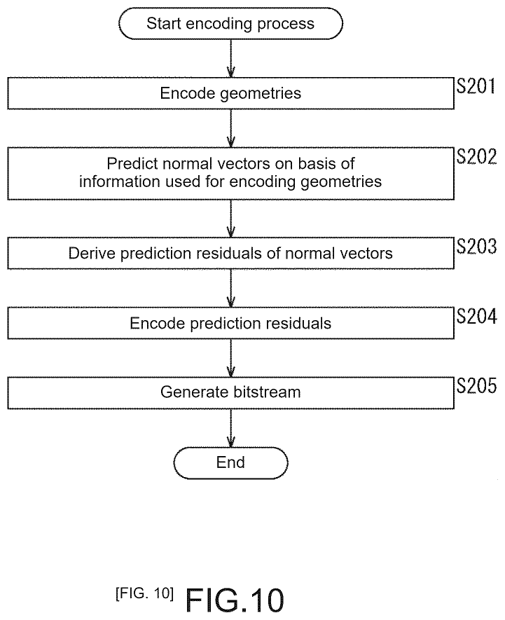

With reference to a flowchart illustrated in FIG. 10, an example of a flow of the encoding process executed by the encoding device 200 will be described.

When the encoding process starts, the geometry encoding section 101 of the encoding device 200 encodes geometries in Step S201.

In Step S202, the normal vector prediction section 103 predicts normal vectors on the basis of information used for encoding the geometries in Step S201, and derives prediction values of the normal vectors. For example, the normal vector prediction section 103 may derive the prediction values on the basis of map information (adjacent dot distribution map) indicating geometries adjacent to a processing target. Alternatively, the normal vector prediction section 103 may derive the prediction values on the basis of table information (look-ahead table) based on the octree structure of geometries. Alternatively, the normal vector prediction section 103 may use, as the prediction values, normal vectors of planes that have been predicted with regard to geometries having trisoup structures.

Respective processes in Steps S203 to S205 are executed in ways similar to the respective processes in Steps S104 to S106 illustrated in FIG. 5. When the process in Step S205 ends, the encoding process ends.

By executing the above-described processes, the encoding device 200 makes it possible to predict the normal vectors with sufficiently high prediction accuracy on the basis of the information to be used for encoding the geometries. Accordingly, the encoding device 200 makes it possible to suppress deterioration in efficiency of encoding ((normal vectors serving as) attributes of) the point cloud.

### <Decoding Device>

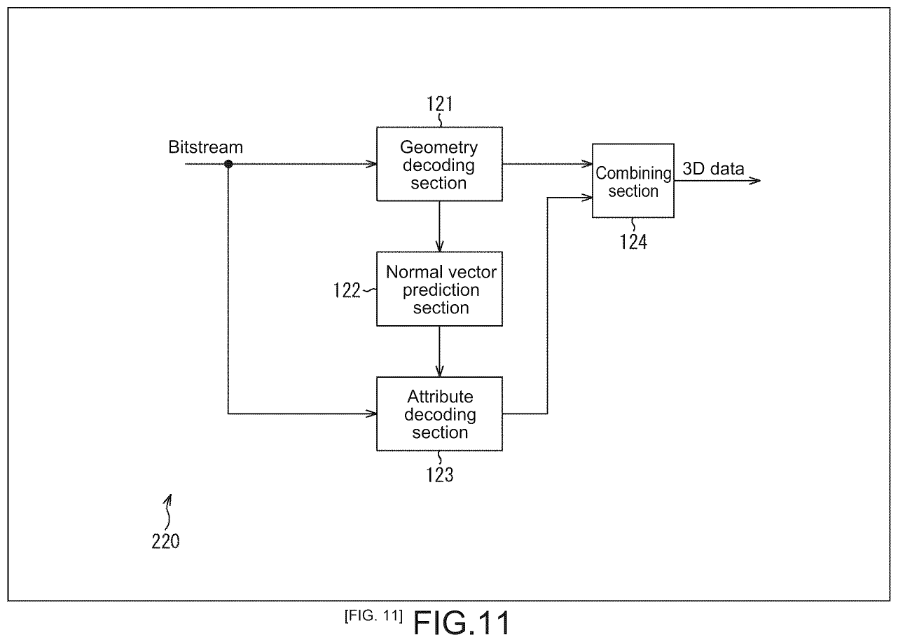

FIG. 11 is a block diagram illustrating an example of a configuration of a decoding device as an aspect of an information processing device to which the present technology is applied. A decoding device 220 illustrated in FIG. 11 is a device that decodes encoded data (bitstream) of a point cloud. The decoding device 220 decodes a bitstream through the GPCC described in Non-Patent Literature 1 to generate (restore) the point cloud. In addition, the decoding device 220 applies the above-described method 1-2 to decode the encoded data of ((prediction residuals of) normal vectors serving as) attributes of the point cloud. For example, the decoding device 220 decodes the bitstream generated by the encoding device 200 (FIG. 9).

Note that, FIG. 11 merely illustrates principal ones among processing sections, data flows, and the like, and does not illustrate all of them. That is, with regard to the decoding device 220, there may be a processing section not illustrated as a block in FIG. 11, or there may be a flow of processing or data not illustrated as an arrow or the like in FIG. 11.

As illustrated in FIG. 11, the decoding device 220 includes the geometry decoding section 121, the normal vector prediction section 122, the attribute decoding section 123, and the combining section 124.

In a way similar to the case illustrated in FIG. 6, the geometry decoding section 121 acquires the bitstream (encoded data of point cloud) supplied to the decoding device 220, decodes encoded data of geometries included in the bitstream, and generates (restores) the geometries. The geometry encoding section 121 supplies the generated (restored) geometries to the combining section 124. In addition, the geometry encoding section 121 supplies the normal vector prediction section 122 with information to be used for encoding the geometries (for example, analysis of octree). Any information can be used as such information. For example, such information may be the adjacent dot distribution map, the look-ahead table, or the plane predicted through the trisoup.

The normal vector prediction section 122 acquires the information (information to be used for decoding geometries) supplied from the geometry encoding section 121, predicts normal vectors by using the information, and derives prediction values (prediction vectors) of the normal vectors. The normal vector prediction section 122 supplies the derived prediction values to the attribute decoding section 123.

Any method can be used as a method of predicting normal vectors on the basis of the information to be used for decoding geometries. For example, the normal vector prediction section 122 may apply the method 1-2-1 and derive the prediction values on the basis of map information (adjacent dot distribution map) indicating points adjacent to an encoding target point in the octree structure. Alternatively, the normal vector prediction section 122 may apply the method 1-2-2 and derive the prediction values on the basis of table information (look-ahead table) based on the octree structure. Alternatively, the normal vector prediction section 122 may apply the method 1-2-3, and set, as the prediction value, a normal of a triangular face of the geometry that has been encoded at a level of an octree having predetermined resolution. The triangular face of the geometry may be a face to be subjected to the trisoup decoding process at a time of decoding. In any of these cases, planes are estimated by using the information to be used for encoding the geometries, and normal vectors of the planes are used as the prediction values. This makes it possible to obtain the prediction values with sufficiently high accuracy. Also, in any of these cases, the adjacent point search is not necessary unlike the method 1-1. This makes it possible to suppress increase in processing load due to predict normal vectors.

The attribute encoding section 123 and the combining section 124 execute their processes in ways similar to the case illustrated in FIG. 6.

The decoding device 220 including such structural elements makes it possible to predict the normal vectors with sufficiently high prediction accuracy on the basis of the information to be used for decoding the geometries. Accordingly, the decoding device 220 makes it possible to suppress deterioration in efficiency of encoding ((normal vectors serving as) attributes of) the point cloud.

### <Flow of Decoding Process>

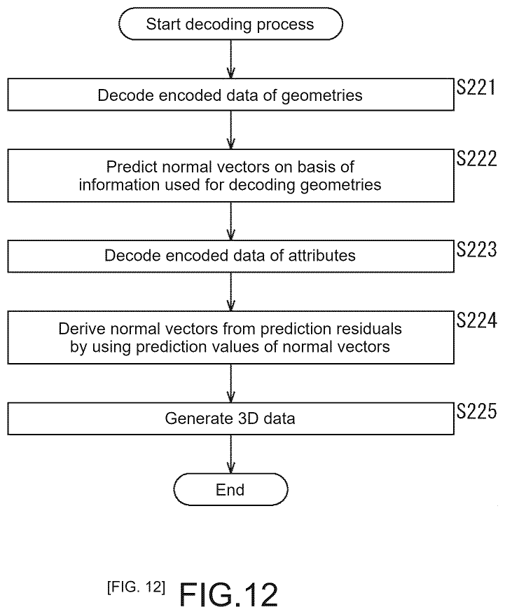

With reference to a flowchart illustrated in FIG. 12, an example of a flow of the decoding process executed by the decoding device 220 will be described.

When the decoding process starts, the geometry decoding section 121 of the decoding device 220 decodes encoded data of geometries in Step S221.

In Step S222, the normal vector prediction section 122 predicts normal vectors on the basis of information used for encoding the geometries in Step S221, and derives prediction values of the normal vectors. For example, the normal vector prediction section 122 may derive the prediction values on the basis of map information (adjacent dot distribution map) indicating geometries adjacent to a processing target. Alternatively, the normal vector prediction section 122 may derive the prediction values on the basis of table information (look-ahead table) based on the octree structure of geometries. Alternatively, the normal vector prediction section 122 may use, as the prediction values, normal vectors of planes that have been predicted with regard to geometries having trisoup structures.

Respective processes in Steps S223 to S225 are executed in ways similar to the respective processes in Steps S123 to S125 illustrated in FIG. 7. When the process in Step S225 ends, the decoding process ends.

By executing the above-described processes, the decoding device 220 makes it possible to predict the normal vectors with sufficiently high prediction accuracy on the basis of the information to be used for decoding geometries. Accordingly, the decoding device 220 makes it possible to suppress deterioration in efficiency of encoding ((normal vectors serving as) attributes of) the point cloud.

### <Method 1-3>

In addition, for example, attributes other than the normal vector can be used as the “information other than the normal vector” to predict the normal vector. In other words, in a case where the above-described method 1 is applied, a normal vector may be predicted on the basis of attributes other than the normal vector as illustrated in a seventh row from the top of the table in FIG. 2 (method 1-3). The attributes other than the normal vector may have compression distortion. In other words, it is possible to generate an attribute that is other than the normal vector and that has compression distortion by encoding and decoding the attribute other than the normal vector, and predict the normal vector on the basis of the attribute that is other than the normal vector and that has compression distortion.

For example, the above-described information processing device including the normal vector prediction section, the prediction residual generation section, and the prediction residual encoding section may further include: an attribute encoding section configured to encode an attribute of a point cloud data as encoded information; and an attribute decoding section configured to decode the attribute that has been encoded. In this case, the normal vector prediction section may derive the prediction value on the basis of the attribute that has been decoded.

In addition, for example, the above-described information processing device including the normal vector prediction section and the normal vector decoding section may further include an attribute decoding section configured to decode an attribute of the point cloud data that has been encoded as the encoded information. In this case, the normal vector prediction section may derive the prediction value on the basis of the attribute that has been decoded.

For example, in the GPCC described in Non-Patent Literature 1 or the like, it is possible to use information other than the normal vectors as attributes. Attributes with compression distortion are obtained by encoding and decoding the attributes. Therefore, it is also easy for a decoding-side device to obtain them. In addition, as will be described later, it is also possible to predict normal vectors at respective points with sufficiently high prediction accuracy on the basis of the attributes other than the normal vectors. Accordingly, by applying the method 1-3, it is possible to suppress deterioration in encoding efficiency.

### <Method 1-3-1>

Note that, the “attributes other than the normal vectors” can be any information except normal vectors. For example, the attributes may be reflectance. In other words, in a case where the above-described method 1-3 is applied, a normal vector may be predicted on the basis of the reflectance as illustrated in an eighth row from the top of the table in FIG. 2 (method 1-3-1).

For example, in the case where the information processing device includes the normal vector prediction section, the prediction residual generation section, the prediction residual encoding section, the attribute encoding section, and the attribute decoding section as described above, an attribute that has been decoded may include information related to the reflectance, and the normal vector prediction section may derive a prediction value on the basis of the reflectance.

In addition, for example, in the case where the information processing device includes the normal vector prediction section, the normal vector decoding section, and the attribute decoding section as described above, an attribute that has been decoded may include information related to the reflectance, and the normal vector prediction section may derive a prediction value on the basis of the reflectance.

If material of an object surface is known, it is possible to estimate an angle (in other words, normal vector) of the surface on the basis of the magnitude of the reflectance. For example, the normal vector has a smaller angle with respect to a viewpoint position direction as the reflectance gets larger. Also, the normal vector has a larger angle with respect to the viewpoint position direction as the reflectance gets smaller. Accordingly, it is possible to predict normal vectors with sufficiently high prediction accuracy by deriving prediction values on the basis of reflectance through the use of such a relation.

### <Method 1-3-2>

Also, the “attributes other than the normal vector” may be a light reflection model. In other words, in a case where the above-described method 1-3 is applied, a normal vector may be predicted on the basis of the light reflection model as illustrated in a ninth row from the top of the table in FIG. 2 (method 1-3-2).

For example, in the case where the information processing device includes the normal vector prediction section, the prediction residual generation section, the prediction residual encoding section, the attribute encoding section, and the attribute decoding section as described above, an attribute that has been decoded may include information related to the light reflection model, and the normal vector prediction section may derive a prediction value on the basis of the light reflection model.

In addition, for example, in the case where the information processing device includes the normal vector prediction section, the normal vector decoding section, and the attribute decoding section as described above, an attribute that has been decoded may include information related to the light reflection model, and the normal vector prediction section may derive a prediction value on the basis of the light reflection model.

General light diffuse reflection models include a Lambertian reflection model. The Lambertian reflection model makes it possible to represent reflected light intensity IR of diffuse reflection by equations (1) and (2) listed below.

$$IR = Ia + Iin * kd * cos α \qquad ( 1 )$$

$$cos α = \frac{N \cdot L}{\vert N \vert \vert L \vert} \qquad ( 2 )$$

where IR represents reflected light intensity, Ia represents ambient light intensity, Iin represents incident height intensity, kd represents diffuse reflection coefficient, N represents normal (normal vector) of face, and L represents light incident direction (incident vector).

If incident light is assumed to be laser light, the incident height intensity can ideally be constant (Iin=1). In this case, it is less affected by ambient light components, and the ambient light intensity is considered to be 0 (Ia=0), ideally. In addition, the laser light attenuates with distance. Therefore, the reflected light intensity depends on a shape, material, and distance of an object face on which the laser light is reflected. The material of the object face can be represented by the diffuse reflection coefficient kd. A distance to the object face can be represented by a distance attenuation Zatt of the laser light. Furthermore, the shape of the object face can be represented by an incident angle θ of the laser light with respect to (a normal line of) the object face. That is, in a case where the incident light is the laser light, reflected light intensity R of diffuse reflection can be expressed by equations (3) and (4) listed below.

$$R = Z att * kd * cos θ \qquad ( 3 )$$

$$cos θ = \frac{- L \cdot N}{\vert L \vert \vert N \vert} \qquad ( 4 )$$

Here, if the diffuse reflection coefficient kd representing the material of the object face and the distance attenuation Zatt of the laser light representing the distance to the object face are known, it is possible to estimate the incident angle θ (that is, normal vector) of the laser light with respect to (the normal line of) the object face on the basis of the reflected light intensity R of diffuse reflection by using such a reflection model. It is possible to predict the normal vectors with sufficiently high accuracy if other data applicable to this model is acquired. It is also possible to predict the normal vectors faster with less processing load.

### <Method 1-3-3>

In addition, in a case where the above-described method 1-3 is applied, a normal vector may be predicted by using a neural network as illustrated in a tenth row from the top of the table in FIG. 2 (method 1-3-3).

For example, in the case where the information processing device includes the normal vector prediction section, the prediction residual generation section, the prediction residual encoding section, the attribute encoding section, and the attribute decoding section as described above, the normal vector prediction section may derive a prediction value of a normal vector by using a neural network that outputs the prediction value on the basis of a captured image.

In addition, for example, in the case where the information processing device includes the normal vector prediction section, the normal vector decoding section, and the attribute decoding section as described above, the normal vector prediction section may derive a prediction value of a normal vector by using the neural network that outputs the prediction value on the basis of a captured image.

A neural network that is trained to output normal vectors of surfaces of objects included in a captured image when the captured image is input may be prepared (for example, see https://www.cs.cmu.edu/~xiaolonw/papers/deep3d.pdf, https://openaccess.thecvf.com/content_CVPR_2019/papers/Zeng_Deep_Surface_Normal_Estimation_With_Hierarchical_R GB-D_Fusion_CVPR_2019_paper.pdf), and prediction values of normal vectors may be derived by inputting a captured image of an object compatible with a point cloud into the neural network. Such a method makes it possible to predict the normal vectors with sufficiently high accuracy.

### <Combination>

It is also possible to combine two or more among the above-described methods 1-3-1 to 1-3-3. These methods are combined in any way. For example, methods may be selected from among the methods 1-3-1 to 1-3-3 under any condition, and normal vectors may be predicted by applying the selected methods. Alternatively, normal vectors may be predicted through the respective methods 1-3-1 to 1-3-3, prediction values obtained from the respective methods may be evaluated (by using a cost function or the like, for example), and an optimal prediction value may be selected on the basis of results of the evaluation. Alternatively, normal vectors may be predicted through two or more methods among the methods 1-3-1 to 1-3-3, and prediction values obtained through the respective methods may be combined, and a final prediction value (prediction value to be used for deriving prediction residual or normal vector) may be derived.

Alternatively, it is also possible to combine each of the methods 1-3-1 to 1-3-3 with another method. In this case, a combination way similar to the above-described examples is used.

Alternatively, it is also possible to combine two or more among the method 1-1, the method 1-2 (that may include the methods 1-2-1 to 1-2-3), and the method 1-3 (that may include the methods 1-3-1 to 1-3-3). In this case, a combination way similar to the above-described examples is used.

### <Encoding Device>

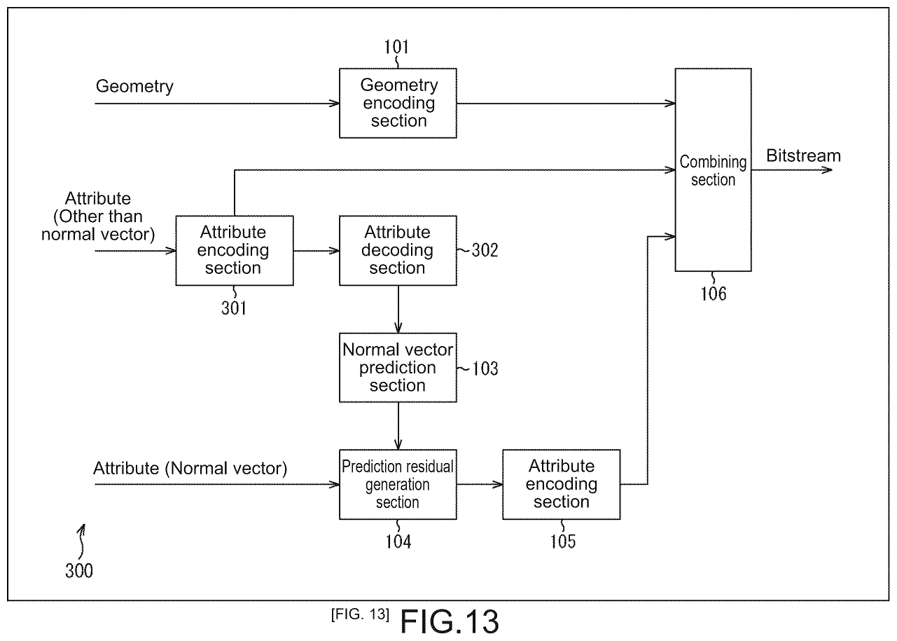

FIG. 13 is a block diagram illustrating an example of a configuration of an encoding device as an aspect of an information processing device to which the present technology is applied. An encoding device 300 illustrated in FIG. 13 is a device that encodes a point cloud. The encoding device 300 encodes a point cloud through the GPCC described in Non-Patent Literature 1. In addition, the encoding device 300 applies the above-described method 1-3 to encode a normal vector that is an attribute of the point cloud.

Note that, FIG. 13 merely illustrates principal ones among processing sections, data flows, and the like, and does not illustrate all of them. That is, with regard to the encoding device 300, there may be a processing section not illustrated as a block in FIG. 13, or there may be a flow of processing or data not illustrated as an arrow or the like in FIG. 13.

As illustrated in FIG. 13, the encoding device 300 includes the geometry encoding section 101, the normal vector prediction section 103, the prediction residual generation section 104, the attribute encoding section 105, the combining section 106, and attribute encoding section 301, and an attribute decoding section 302.

In a way similar to the case illustrated in FIG. 4, the geometry encoding section 101 acquires and encodes geometries and generates encoded data of the geometries. The geometry encoding section 101 supplies the generated encoded data of the geometries to the combining section 106.

The attribute encoding section 301 acquires and encodes attributes other than normal vectors of a point cloud supplied to the encoding device 300, and generates encoded data of the attributes other than the normal vectors. Any method can be used as a method of encoding the attributes other than the normal vectors.

For example, the attribute encoding section 301 may encode the attributes other than the normal vectors through a method including arithmetic encoding. For example, the attribute encoding section 301 may apply the method described in Non-Patent Literature 1. The attribute encoding section 301 supplies the generated encoded data of the attributes other than the normal vectors to the combining section 106. The attribute encoding section 301 also supplies the generated encoded data of the attributes other than the normal vectors to the attribute decoding section 302.

The attribute decoding section 302 acquires the encoded data supplied from the attribute encoding section 301, decodes the encoded data, and generates (restores) the attributes other than the normal vectors. Any decoding method can be used as a method of decoding the encoded data as long as the method is compatible with the encoding method applied by the attribute encoding section 301. For example, the attribute decoding section 302 may decode the encoded data through a method including arithmetic decoding. For example, the attribute decoding section 302 may apply the method described in Non-Patent Literature 1. Note that, the generated (restored) attributes other than the normal vectors have compression distortion. In other words, it is possible to obtain information that is same as information obtained by a decoding-side device. The attribute decoding section 302 supplies the normal vector prediction section 103 with the generated attributes other than the normal vectors (attributes that are other than the normal vector and that have compression distortion).

Note that, a purpose of the decoding of the encoded data of attributes other than the normal vectors by the attribute decoding section 302 is to generate the attributes that are other than the normal vector and that have compression distortion. Therefore, reversible arithmetic encoding/arithmetic decoding may be omitted with regard to the encoded data to be processed by the attribute decoding section 302. In other words, it is also possible for the attribute encoding section 301 to supply data before the arithmetic encoding to the attribute decoding section 302. In this case, the attribute decoding section 302 may use the data (without performing the arithmetic decoding) to generate attributes that are other than the normal vector and that have compression distortion.

In addition, the attributes other than the normal vectors can be any information except the normal vectors. For example, the attributes may be reflectance, reflection models, or captured images. The normal vector prediction section 103 acquires attributes supplied from the attribute decoding section 302 (attributes that are other than the normal vector and that have compression distortion), predicts normal vectors by using the attributes other than the normal vectors, and derives prediction values (prediction vectors) of the normal vectors. The normal vector prediction section 103 supplies the derived prediction values to the prediction residual generation section 104.

Any method can be used as a method of predicting the normal vectors on the basis of the attributes other than the normal vectors. For example, the normal vector prediction section 103 may apply the method 1-3-1 and derive the prediction values on the basis of the reflectance. Alternatively, the normal vector prediction section 103 may apply the method 1-3-2 and derive the prediction values on the basis of the light reflection model. Alternatively, the normal vector prediction section 103 may apply the method 1-3-3 and derive the prediction values of the normal vectors by inputting the captured image into the neural network. In any of these cases, it is possible to obtain the prediction values with sufficiently high accuracy.

The prediction residual generation section 104 and the attribute encoding section 105 execute their processes in ways similar to the case illustrated in FIG. 4.

The combining section 106 acquires encoded data of geometries supplied from the geometry encoding section 101. The combining section 106 also acquires encoded data of the attributes that are other than the normal vectors and that are supplied from the attribute encoding section 301. The combining section 106 also acquires encoded data of attributes supplied from the attribute encoding section 105 (encoded data of prediction residuals of normal vectors). The combining section 106 generates encoded data (bitstream) of the point cloud including the acquired encoded data of the geometries, the acquired encoded data of the attributes other than the normal vectors, and the acquired encoded data of the prediction residuals of the normal vectors. The combining section 106 outputs the generated bitstream to an outside of the encoding device 100. For example, the bitstream may be stored in any storage medium or may be transmitted to another device (for example, decoding device) via any communication medium.

The encoding device 300 including such structural elements makes it possible to predict the normal vectors with sufficiently high prediction accuracy on the basis of the attributes other than the normal vectors. Accordingly, the encoding device 300 makes it possible to suppress deterioration in efficiency of encoding ((normal vectors serving as) attributes of) the point cloud.

### <Flow of Encoding Process>

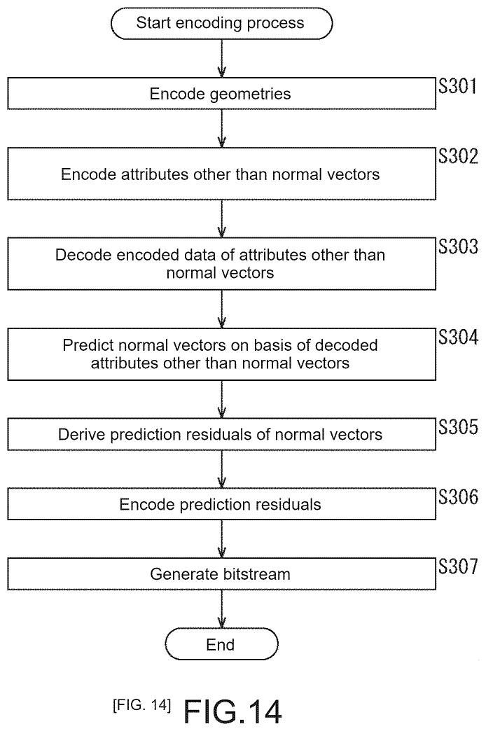

With reference to a flowchart illustrated in FIG. 14, an example of a flow of the encoding process executed by the encoding device 300 will be described.

When the encoding process starts, the geometry encoding section 101 of the encoding device 300 encodes geometries in Step S301.

In Step S302, the attribute encoding section 301 encodes attributes other than normal vectors.

In Step S303, the attribute decoding section 302 decodes encoded data of the attributes other than the normal vectors that has been generated in Step S302.

In Step S304, the normal vector prediction section 103 predicts the normal vectors on the basis of the attributes that are other than the normal vectors and that have been obtained through the decoding in Step S303, and derives prediction values of the normal vectors. For example, the normal vector prediction section 103 may derive the prediction values on the basis of the reflectance. Alternatively, the normal vector prediction section 103 may derive the prediction values on the basis of the reflection model. Alternatively, the normal vector prediction section 103 may derive the prediction values of the normal vectors by inputting the captured image into the neural network.

Respective processes in Steps S305 to S306 are executed in ways similar to the respective processes in Steps S104 to S105 illustrated in FIG. 5.

In Step S307, the combining section 106 combines the encoded data of the geometries generated in Step S301, the encoded data of the attributes other than the normal vectors generated in Step S302, and the encoded data of (prediction residuals of) the normal vectors generated in Step S306, and generates encoded data (bitstream) of a point cloud.

When the process in Step S307 ends, the encoding process ends.

By executing the above-described processes, the encoding device 300 makes it possible to predict the normal vectors with sufficiently high prediction accuracy on the basis of the attributes other than the normal vectors. Accordingly, the encoding device 300 makes it possible to suppress deterioration in efficiency of encoding ((normal vectors serving as) attributes of) the point cloud.

### <Decoding Device>

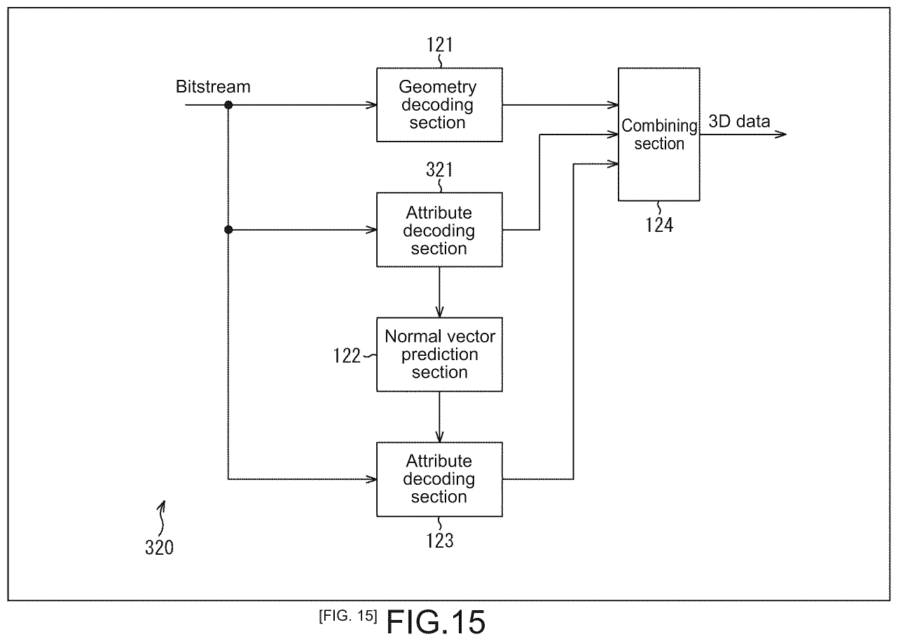

FIG. 15 is a block diagram illustrating an example of a configuration of a decoding device as an aspect of an information processing device to which the present technology is applied. A decoding device 320 illustrated in FIG. 15 is a device that decodes encoded data (bitstream) of a point cloud. The decoding device 320 decodes a bitstream through the GPCC described in Non-Patent Literature 1 to generate (restore) the point cloud. In addition, the decoding device 320 applies the above-described method 1-3 to decode the encoded data of ((prediction residuals of) normal vectors serving as) attributes of the point cloud. For example, the decoding device 320 decodes the bitstream generated by the encoding device 300 (FIG. 13).

Note that, FIG. 15 merely illustrates principal ones among processing sections, data flows, and the like, and does not illustrate all of them. That is, with regard to the decoding device 320, there may be a processing section not illustrated as a block in FIG. 15, or there may be a flow of processing or data not illustrated as an arrow or the like in FIG. 15.

As illustrated in FIG. 15, the decoding device 320 includes the geometry decoding section 121, the normal vector prediction section 122, the attribute decoding section 123, the combining section 124, and an attribute decoding section 321.

In a way similar to the case illustrated in FIG. 6, the geometry decoding section 121 acquires a bitstream (encoded data of point cloud) supplied to the decoding device 220, decodes encoded data of geometries included in the bitstream, and generates (restores) the geometries. The geometry encoding section 121 supplies the generated (restored) geometries to the combining section 124.

The attribute decoding section 321 acquires the bitstream (encoded data of point cloud) supplied to the decoding device 220, decodes the encoded data of attributes other than the normal vectors included in the bitstream, and generates (restores) the attributes other than the normal vectors. In other words, the attribute decoding section 321 decodes attributes of the point cloud data that have been encoded as encoded information. The attribute decoding section 321 supplies the generated (restored) attributes other than the normal vectors to the combining section 124. The attribute decoding section 321 also supplies the generated (restored) attributes other than the normal vectors to the normal vector prediction section 122. The attributes can be any information except the normal vectors. For example, the attributes may be reflectance, reflection models, or captured images.

The normal vector prediction section 122 acquires the attributes other than the normal vectors supplied from the geometry decoding section 121, predicts normal vectors by using the attributes, and derives prediction values (prediction vectors) of the normal vectors. The normal vector prediction section 122 supplies the derived prediction values to the attribute decoding section 123.

The attribute decoding section 123 executes its process in a way similar to the case illustrated in FIG. 6.

The combining section 124 acquires the geometries supplied from the geometry decoding section 121. The combining section 124 also acquires the attributes that are other than the normal vectors and that are supplied from the attribute decoding section 321. The combining section 124 also acquires the normal vectors supplied from the attribute decoding section 123. The combining section 124 combines the acquired geometries, the acquired attributes other than the normal vectors, and the acquired normal vectors (attributes) to generate data (3D data) of the point cloud. The combining section 124 outputs the generated 3D data to an outside of the decoding device 120. For example, the 3D data may be stored in any storage medium or may be rendered and displayed on another device.

The decoding device 320 including such structural elements makes it possible to predict the normal vectors with sufficiently high prediction accuracy on the basis of the attributes other than the normal vectors. Accordingly, the decoding device 320 makes it possible to suppress deterioration in efficiency of encoding ((normal vectors serving as) attributes of) the point cloud.

### <Flow of Decoding Process>

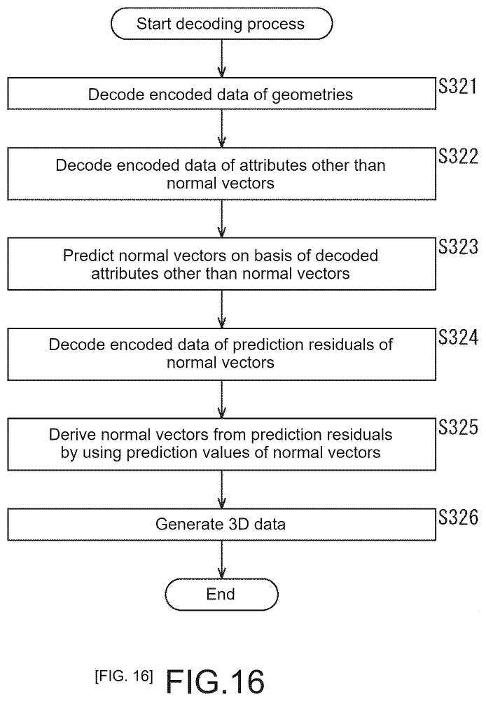

With reference to a flowchart illustrated in FIG. 16, an example of a flow of the decoding process executed by the decoding device 320 will be described.

When the decoding process starts, the geometry decoding section 121 of the decoding device 320 decodes encoded data of geometries in Step S321.

In Step S322, the attribute encoding section 321 decodes encoded data of attributes other than normal vectors.

In Step S323, the normal vector prediction section 122 predicts the normal vectors on the basis of the attributes that are other than the normal vectors and that have been obtained through the decoding in Step S322, and derives prediction values of the normal vectors. For example, the normal vector prediction section 122 may derive the prediction values on the basis of the reflectance. Alternatively, the normal vector prediction section 122 may derive the prediction values on the basis of the reflection model.

Alternatively, the normal vector prediction section 122 may derive the prediction values of the normal vectors by inputting the captured image into the neural network.

In Step S324, the attribute decoding section 123 decodes encoded data of prediction residuals of the normal vectors and generates (restores) the prediction residuals.

In Step S325, the attribute decoding section 123 adds the prediction values corresponding to the prediction residuals derived in Step S323 to the prediction residuals generated (restored) in Step S324, and derives the normal vectors.

In Step S326, the combining section 124 combines the geometries generated (restored) in Step S321, the attributes other than the normal vectors generated (restored) in Step S322, and the normal vectors derived in Step S325, and generates data (3D data) of a point cloud.

When the process in Step S326 ends, the decoding process ends.

By executing the above-described processes, the decoding device 320 makes it possible to predict the normal vectors with sufficiently high prediction accuracy on the basis of the attributes other than the normal vectors. Accordingly, the decoding device 320 makes it possible to suppress deterioration in efficiency of encoding ((normal vectors serving as) attributes of) the point cloud.

### <Method 1-4>

The methods of predicting normal vectors on the basis of information other than the normal vectors have been described above. These method are usable in conjunction with intra prediction for making a prediction on the basis of another normal vector in a frame. In other words, in a case where the above-described method 1 is applied, prediction of a normal vector based on information other than the normal vector and intra prediction of the normal vector may be used together as illustrated in an 11th row from the top of the table in FIG. 2 (method 1-4).

For example, the above-described information processing device including the normal vector prediction section, the prediction residual generation section, and the prediction residual encoding section may further include an intra prediction section configured to derive a prediction value of a normal vector through intra prediction based on a normal vector of a geometry (point) adjacent to a processing target. In this case, the prediction residual generation section may generate a prediction residual by using at least one of a prediction value derived by the normal vector prediction section or a prediction value derived by the intra prediction section. In this specification, sometimes the prediction value derived by the intra prediction section may be referred to as a “second prediction value” to distinguish between them.

In addition, for example, the above-described information processing device including the normal vector prediction section and the normal vector decoding section may further include an intra prediction section configured to derive a second prediction value of a yet-to-be-encoded normal vector of an encoding target point through intra prediction based on a normal vector of a point adjacent to the processing target point. In this case, the normal vector decoding section may derive the yet-to-be-encoded normal vector of the encoding target point by adding at least one of a prediction value derived by the normal vector prediction section or the second prediction value derived by the intra prediction section to a prediction residual.

The normal vector may be predicted on the basis of information other than the normal vector through any method among the method 1, the methods 1-1 to 1-3, the methods 1-2-1 to 1-2-3, and the methods 1-3-1 to 1-3-3 that have been described above. Also, it is also possible to combine two or more among these methods with the intra prediction of normal vectors.

### <Method 1-4-1>

Any combination can be used as the above-described combination between these methods and the intra prediction of normal vectors. For example, in a case where the above-described method 1-4 is applied, an optimal method (or a prediction values derived through this method) may be selected on the basis of rate-distortion (RD) cost as illustrated in a 12th row from the top of the table in FIG. 2 (method 1-4-1).

For example, in the case where the above-described information processing device includes the normal vector prediction section, the prediction residual generation section, the prediction residual encoding section, the intra prediction section, and a selector section, the selector section may select one of the prediction value and the second prediction value, and the prediction residual generation section may generate a prediction residual by using the value selected by the selector section from among the prediction value and the second prediction value. In addition, the selector section may select the prediction value on the basis of the RD cost.

In addition, for example, in the case where the above-described information processing device includes the normal vector prediction section, the normal vector decoding section, the intra prediction section, and a selector section, the selector section may select one of the prediction value and the second prediction value, and the normal vector decoding section may derive a normal vector corresponding to a geometry of a processing target by adding the prediction value or the second prediction value selected by the selector section to a prediction residual. In addition, the selector section may select the prediction value on the basis of the RD cost.

By selecting an optimal prediction method on the basis of the RD cost as described above, it is possible for the information processing device to suppress deterioration in encoding efficiency.

Note that, it is also possible to transmit flag information indicating the selected prediction method from the encoding side to the decoding side. For example, in the case where the above-described information processing device includes the normal vector prediction section, the prediction residual generation section, the prediction residual encoding section, the intra prediction section, and the selector section, the selector section may set a flag indicating a result of selection. In addition, the prediction residual encoding section may encodes the flag. In addition, for example, in the case where the information processing device includes the normal vector prediction section, the normal vector decoding section, the intra prediction section, and the selector section, the selector section may select a prediction value on the basis of a flag indicating a prediction value derivation method applied at a time of encoding. This allows the decoding side to select a same derivation method (prediction value derived through this method) as the encoding side.

### <Encoding Device>

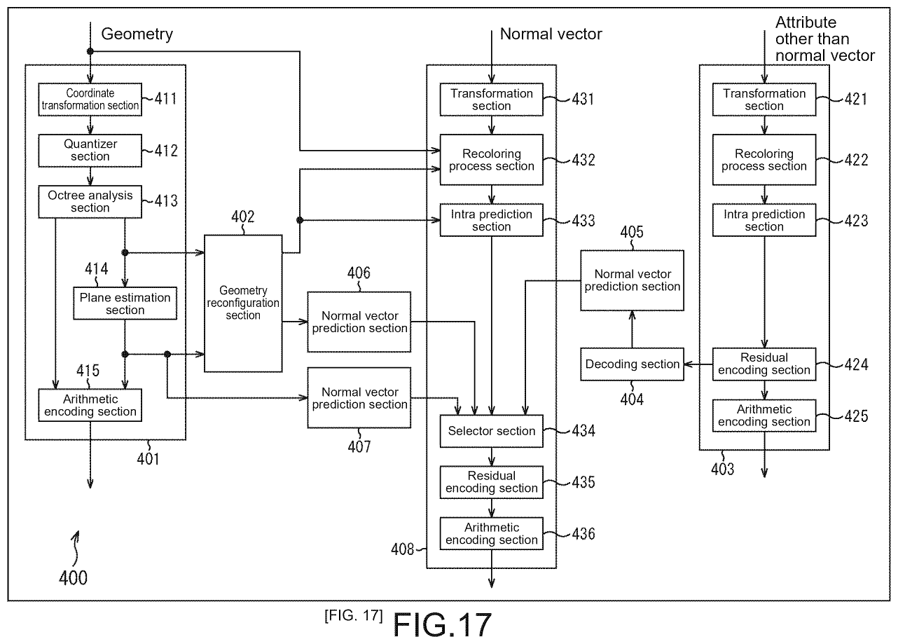

FIG. 17 is a block diagram illustrating an example of a configuration of an encoding device as an aspect of an information processing device to which the present technology is applied. An encoding device 400 illustrated in FIG. 17 is a device that encodes a point cloud. The encoding device 400 encodes a point cloud through the GPCC described in Non-Patent Literature 1. In addition, the encoding device 400 applies the above-described method 1-4 to encode normal vectors that are attributes of the point cloud.

Note that, FIG. 17 merely illustrates principal ones among processing sections, data flows, and the like, and does not illustrate all of them. That is, with regard to the encoding device 400, there may be a processing section not illustrated as a block in FIG. 17, or there may be a flow of processing or data not illustrated as an arrow or the like in FIG. 17.

As illustrated in FIG. 17, the encoding device 400 includes a geometry encoding section 401, a geometry reconfiguration section 402, an attribute encoding section 403, a decoding section 404, a normal vector prediction section 405, a normal vector prediction section 406, a normal vector prediction section 407, and a normal vector encoding section 408.

In addition, the geometry encoding section 401 includes a coordinate transformation section 411, a quantizer section 412, an octree analysis section 413, a plane estimation section 414, and an arithmetic encoding section 415. In addition, the attribute encoding section 403 includes a transformation section 421, a recoloring process section 422, an intra prediction section 423, a residual encoding section 424, and an arithmetic encoding section 425. The normal vector encoding section 408 includes a transformation section 431, a recoloring process section 432, an intra prediction section 433, a selector section 434, a residual encoding section 435, and an arithmetic encoding section 436.

The geometry encoding section 401 performs a process similar to the geometry encoding section 101 (FIG. 4 and FIG. 9). Note that, the geometry encoding section 401 is assumed to encode geometries by applying the trisoup.

The coordinate transformation section 411 transforms a coordinate system of acquired geometries as necessary (for example, the coordinate transformation section 411 transforms a polar coordinate system into an xyz coordinate system). The coordinate transformation section 411 supplies the quantizer section 412 with the geometries in the coordinate system that has been transformed as necessary.

The quantizer section 412 quantizes the supplied geometries, transforms them into voxel data, and supplies the voxel data to the octree analysis section 413. The octree analysis section 413 tree-structures the supplied voxel data (geometries) until its middle level, and generates an octree. The quantizer section 412 supplies the tree-structured geometries to the plane estimation section 414 and the arithmetic encoding section 415. In addition, the quantizer section 412 supplies the geometries to the geometry reconfiguration section 402.

The plane estimation section 414 estimates planes through the trisoup (estimates triangular faces to obtain geometries at lower levels (higher resolution) than the octree). The plane estimation section 414 supplies information related to the estimated planes to the arithmetic encoding section 415. The plane estimation section 414 also supplies information indicating the estimated planes to the geometry reconfiguration section 402 and the normal vector prediction section 407.

The arithmetic encoding section 415 perform arithmetic encoding on the supplied information (tree-structured geometries, information related to estimated planes, and the like) and generate encoded data of the geometries. The arithmetic encoding section 415 outputs the encoded data of the geometries.

The geometry reconfiguration section 402 performs a process similar to the geometry decoding section 102 (FIG. 4). For example, the geometry reconfiguration section 402 acquires tree-structured geometries supplied from the octree analysis section 413. The geometry reconfiguration section 402 also acquires the information indicating the estimated planes supplied from the plane estimation section 414. The geometry reconfiguration section 402 reconfigures the geometries by using these information. This makes it possible to obtain geometries with compression distortion. The geometry reconfiguration section 402 supplies the obtained geometries (geometries with compression distortion) to the recoloring process section 422, the intra prediction section 423, the recoloring process section 432, the intra prediction section 433, and the normal vector prediction section 406.

The attribute encoding section 403 performs a process similar to the attribute encoding section 301 (FIG. 13). The transformation section 421 acquires attributes other than normal vectors and transforms the attributes as necessary. The recoloring process section 422 acquires geometries supplied to the encoding device 400 and geometries that are supplied from the geometry reconfiguration section 402 and that have compression distortion. Note that, arrows indicating such data movement are omitted in FIG. 17 for ease of explanation. The recoloring process section 422 performs a recoloring process of correcting the attributes in conformity with the compression distortion of the geometries. The recoloring process section 422 supplies the attributes subjected to the recoloring process to the intra prediction section 423.

The intra prediction section 423 acquires the attributes that are other than the normal vectors and that are supplied from the recoloring process section 422. The intra prediction section 423 also acquires the geometries that have compression distortion and that are supplied from the geometry reconfiguration section 402. Note that, arrows indicating such data movement are omitted in FIG. 17 for ease of explanation. The intra prediction section 423 predicts (performs intra prediction on) attributes other than the normal vector corresponding to a processing target point on the basis of attributes of adjacent points. The intra prediction section 423 supplies the residual encoding section 424 with the attributes other than the normal vectors and their prediction values.

The residual encoding section 424 derives differences (prediction residuals) between the attributes other than the normal vectors and their prediction values that have been supplied. The residual encoding section 424 supplies the prediction residuals to the arithmetic encoding section 425. The residual encoding section 424 also supplies the prediction residuals and the prediction values to the decoding section 404.

The arithmetic encoding section 425 performs arithmetic encoding on the supplied prediction residuals and generates encoded data of the attributes other than the normal vectors. The arithmetic encoding section 425 outputs the encoded data of the attributes other than the normal vectors.

The decoding section 404 performs a process similar to the attribute decoding section 302 (FIG. 13). For example, the decoding section 404 adds the prediction values to the prediction residuals supplied from the residual encoding section 424, generates (restores) the attributes other than the normal vectors, and supplies them to the normal vector prediction section 405.

The normal vector prediction section 405 performs a process similar to the normal vector prediction section 103 (FIG. 13). For example, the normal vector prediction section 405 predicts the normal vectors on the basis of the attributes other than the normal vectors supplied from the decoding section 404, and derives prediction values of the normal vectors. For example, the normal vector prediction section 405 may derive the prediction values of the normal vectors on the basis of the reflectance. Alternatively, the normal vector prediction section 405 may derive the prediction values of the normal vectors on the basis of the reflection model. Alternatively, the normal vector prediction section 405 may derive the prediction values of the normal vectors by inputting the captured image into the neural network. The normal vector prediction section 405 supplies the derived prediction values to the selector section 434.

The normal vector prediction section 406 performs a process similar to the normal vector prediction section 103 (FIG. 4). For example, the normal vector prediction section 406 predicts the normal vectors on the basis of the geometries with compression distortion supplied from the geometry reconfiguration section 402, and derives prediction values of the normal vectors. The normal vector prediction section 406 supplies the derived prediction values to the selector section 434.

The normal vector prediction section 407 performs a process similar to the normal vector prediction section 103 (FIG. 9). For example, the normal vector prediction section 407 predicts the normal vectors on the basis of the “information to be used for encoding geometries” (in this case, information indicating estimated planes) supplied from the plane estimation section 414, and derives prediction values of the normal vectors. Note that, it is possible for the normal vector prediction section 407 to predict the normal vectors on the basis of information other than the information indicating estimated planes, and derive prediction values of the normal vectors, as long as the information is information to be used for encoding geometries. For example, the normal vector prediction section 407 may predict the normal vectors on the basis of the adjacent dot distribution map. Alternatively, the normal vector prediction section 407 may predict the normal vectors on the basis of the table information (LookaheadTable) based on the octree structure. The normal vector prediction section 407 supplies the derived prediction values to the selector section 434.

The normal vector encoding section 408 performs a process similar to the prediction residual generation section 104 and the attribute encoding section 105 (FIG. 4, FIG. 9, and FIG. 13). The transformation section 431 acquires normal vectors as attributes, and transforms the normal vectors as necessary. The recoloring process section 432 acquires geometries supplied to the encoding device 400 and geometries that are supplied from the geometry reconfiguration section 402 and that have compression distortion. The recoloring process section 432 performs a recoloring process of correcting the normal vectors in conformity with the compression distortion of the geometries. The recoloring process section 432 supplies the normal vectors subjected to the recoloring process to the intra prediction section 433.

The intra prediction section 433 acquires the normal vectors supplied from the recoloring process section 432. The intra prediction section 433 also acquires the geometries that have compression distortion and that are supplied from the geometry reconfiguration section 402. The intra prediction section 433 predicts (performs intra prediction on) the normal vector corresponding to the encoding target point on the basis of normal vectors of points adjacent to the encoding target point. In other words, the intra prediction section 433 derives a second prediction value of the yet-to-be-encoded normal vector through intra prediction based on the normal vectors of points adjacent to the encoding target point. The intra prediction section 433 supplies the normal vectors and their prediction values to the selector section 434.

The selector section 434 acquires prediction values supplied from the normal vector prediction section 405 (prediction values derived on the basis of the attributes other than the normal vectors), prediction values supplied from the normal vector prediction section 406 (prediction values derived on the basis of geometries with compression distortion), prediction values supplied from the normal vector prediction section 407 (prediction values derived on the basis of information to be used for encoding geometries), and prediction values supplied from the intra prediction section 433 (prediction values derived through intra prediction of normal vectors). The selector section 434 selects prediction values to be applied from among these prediction values. In other words, the selector section 434 selects prediction values to be applied from among prediction values derived on the basis of the information other than the normal vectors and prediction values derived on the basis of the normal vectors. That is, the selector section 434 selects prediction values to be used from among the plurality of prediction values derived through different methods. For example, the selector section 434 may derives the RD costs with regard to the respective prediction values and select optimal prediction values on the basis of the RD costs. The selector section 434 supplies the residual encoding section 435 with the normal vectors and the selected prediction values corresponding to the normal vectors.

Note that, the selector section 434 may generate flag information indicating results of selection of prediction values. In other words, the selector section 434 may set the flag information indicating a method of deriving the selected prediction values. In this case, the selector section 434 supplies the generated flag information to the residual encoding section 435.

The residual encoding section 435 derives differences (prediction residuals) between the normal vectors and their prediction values that have been supplied. In other words, the residual encoding section 435 subtracts the prediction values that are selected by the selector section 434 and that correspond to the normal vectors from the normal vectors, and generates prediction residuals. In other words, the residual encoding section 435 generates a prediction residual by using at least one of a prediction value derived by any of the normal vector prediction sections 405 to 407 or a prediction value derived by the intra prediction section 433. Therefore, the residual encoding section 435 can also be said as a prediction residual generation section. The residual encoding section 435 supplies the prediction residuals to the arithmetic encoding section 436. Note that, in a case where the selector section 434 supplies the flag information indicating results of selection of prediction values, the residual encoding section 435 supplies the flag information to the arithmetic encoding section 436.

The arithmetic encoding section 436 performs arithmetic encoding on the supplied prediction residuals and generates encoded data of the normal vectors (prediction residuals). The arithmetic encoding section 436 outputs the encoded data of the (prediction residuals of) normal vectors. Note that, in a case where the residual encoding section 435 supplies the flag information indicating results of selection of prediction values, the arithmetic encoding section 436 may perform arithmetic encoding on the flag information and store it into encoded data (bitstream) of the point cloud.

Note that, it is also possible for a combining section (not illustrated) to combine encoded data of geometries output from the arithmetic encoding section 415, encoded data of attributes other than normal vectors output from the arithmetic encoding section 425, and encoded data of normal vectors output from the arithmetic encoding section 436, and generate encoded data (bitstream) of the point cloud including them.

The encoding device 400 including such structural elements makes it possible to select optimal prediction values from among prediction values of normal vectors derived through various methods. Accordingly, the encoding device 400 makes it possible to suppress deterioration in prediction efficiency. Therefore, the encoding device 400 makes it possible to suppress deterioration in encoding efficiency.

### <Flow of Encoding Process>

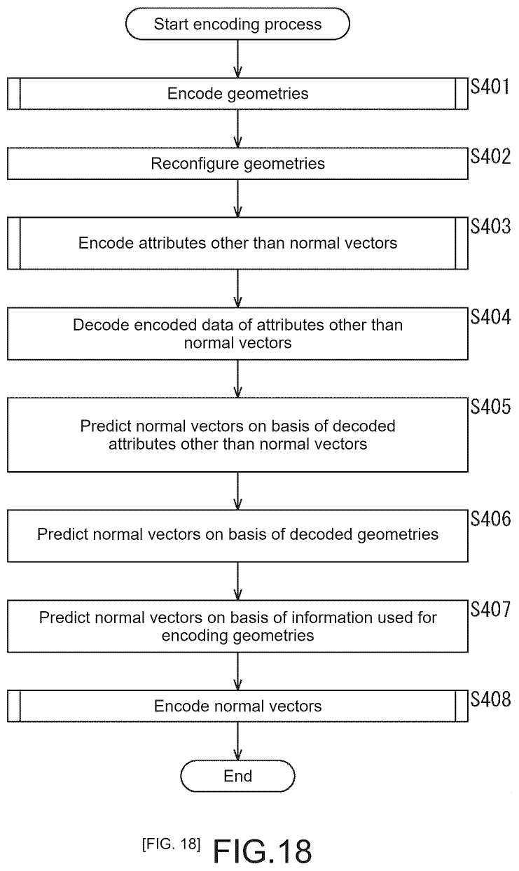

With reference to a flowchart illustrated in FIG. 18, an example of a flow of the encoding process executed by the encoding device 400 will be described.

When the encoding process starts, the geometry encoding section 401 of the encoding device 400 executes a geometry encoding process to encode geometries in Step S401.

In Step S402, the geometry reconfiguration section 402 reconfigures the geometries by using information indicating planes, an octree, or the like obtained in Step S401.

In Step S403, the attribute encoding section 403 executes an attribute encoding process to encode attributes other than normal vectors.

In Step S404, the decoding section 404 decodes encoded data of the attributes other than the normal vectors obtained through the process in Step S403.

In Step S405, the normal vector prediction section 405 predicts the normal vectors on the basis of the attributes other than the normal vectors generated (restored) through the process in Step S404.

In Step S406, the normal vector prediction section 406 predicts the normal vectors on the basis of the geometries with compression distortion obtained through the process in Step S402.

In Step S407, the normal vector prediction section 407 predicts the normal vectors on the basis of information used for encoding the geometries in Step S401.

In Step S408, the normal vector encoding section 408 executes a normal vector encoding process to encode the normal vectors.

When the process in Step S408 ends, the encoding process ends.

### <Flow of Geometry Encoding Process>

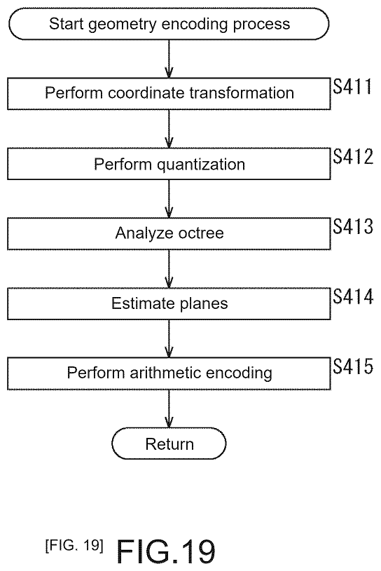

Next, with reference to a flowchart illustrated in FIG. 19, an example of a flow of the geometry encoding process executed in Step S401 of FIG. 18 will be described.

When the geometry encoding process starts, the coordinate transformation section 411 of the geometry encoding section 411 transforms a coordinate system of the geometries as necessary in Step S411.

In Step S412, the quantizer section 412 quantizes the geometries and transforms them into voxel data.

In Step S413, the octree analysis section 413 tree-structures the voxel data and generates an octree from its highest level until its middle level.

In Step S414, the plane estimation section 414 uses the trisoup to estimates planes (triangular faces) for geometries at lower levels (higher resolution) than the levels of the generated octree.

In Step S415, the arithmetic encoding section 415 performs arithmetic encoding on the geometries configured by the octree generated in Step S413, information related to the planes estimated in Step S414, and the like.

When the process in Step S415 ends, the geometry encoding process ends, and the process returns to FIG. 18.

### <Flow of Attribute Encoding Process>

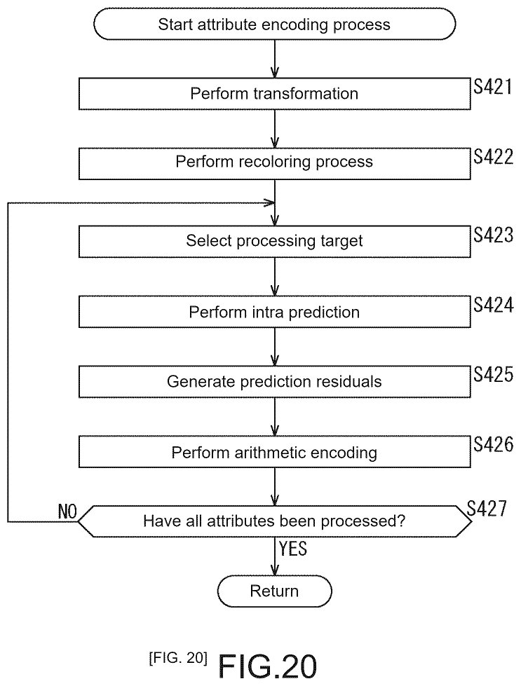

Next, with reference to a flowchart illustrated in FIG. 20, an example of a flow of the attribute encoding process executed in Step S403 of FIG. 18 will be described.

When the attribute encoding process starts, the transformation section 421 of the attribute encoding section 411 transforms attributes other than normal vectors as necessary in Step S421.

In Step S422, the recoloring process section 422 performs a recoloring process to correct the attributes other than the normal vectors in conformity with the compression distortion of the geometries.

In Step S423, the intra prediction section 423 selects a processing target point.

In Step S424, the intra prediction section 423 performs intra prediction on attributes other than a normal vector corresponding to the processing target point on the basis of attributes other than normal vectors corresponding to points adjacent to the processing target point.

In Step S425, the residual encoding section 424 subtracts prediction values derived through the intra prediction in Step S424 from the attributes other than the normal vector corresponding to the processing target point, and generates prediction residuals.

In Step S426, the arithmetic encoding section 425 performs arithmetic encoding on the prediction residuals generated in Step S425 to generate encoded data.

In Step S427, the arithmetic encoding section 425 determines whether or not attributes other than the normal vector have been processed with regard to all the points. In a case where it is determined that there remains an unprocessed attribute, the process returns to Step S423 and selects a new processing target. In other words, the respective processes in Steps S423 to S427 are executed with regard to attributes other than normal vectors of the respective points.

Next, in a case where it is determined that the attributes other than the normal vector have been processed with regard to all the points in Step S427, the attribute encoding process ends and the process returns to FIG. 18.

### <Flow of Normal Vector Encoding Process>

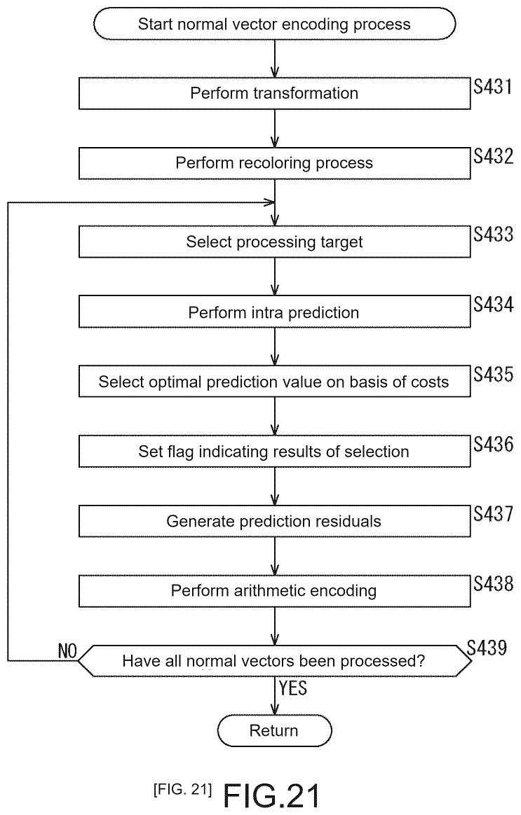

Next, with reference to a flowchart illustrated in FIG. 21, an example of a flow of the normal vector encoding process executed in Step S408 of FIG. 18 will be described.

When the normal vector encoding process starts, the transformation section 431 of the normal vector encoding section 408 transforms normal vectors as necessary in Step S431.

In Step S432, the recoloring process section 432 performs a recoloring process to correct the normal vectors in conformity with the compression distortion of the geometries.

In Step S433, the intra prediction section 433 selects a processing target point.

In Step S434, the intra prediction section 433 performs intra prediction on a normal vector corresponding to the processing target point on the basis of normal vectors corresponding to points adjacent to the processing target point.

In Step S435, the selector section 434 finds RD costs of a plurality of prediction values derived through different methods, and selects an optimal prediction value on the basis of the RD costs. In other words, the selector section 434 finds respective RD costs of prediction values derived on the basis of information other than the normal vectors and prediction values derived on the basis of the normal vectors, and selects an optimal prediction value on the basis of the RD costs. For example, the selector section 434 finds respective RD costs of prediction values derived on the basis of the attributes other than the normal vectors, prediction values derived on the basis of geometries with compression distortion, prediction values derived on the basis of information to be used for encoding geometries, and prediction values derived through intra prediction of normal vectors, and selects an optimal prediction value on the basis of these RD costs.

In Step S436, the selector section 434 sets flag information indicating results of the selection.

In Step S437, the residual encoding section 435 subtracts the prediction value selected in Step S435 from the normal vector corresponding to the processing target point, and generates a prediction residual.

In Step S438, the arithmetic encoding section 436 performs arithmetic encoding on the prediction residual generated in Step S437 to generate encoded data.

In Step S439, the arithmetic encoding section 436 determines whether or not the normal vectors have been processed with regard to all the points. In a case where it is determined that there remains an unprocessed normal vector, the process returns to Step S433 and selects a new processing target. In other words, the respective processes in Steps S433 to S439 are executed with regard to the normal vectors of the respective points.

Next, in a case where it is determined that the normal vectors have been processed with regard to all the points in Step S439, the normal vector encoding process ends and the process returns to FIG. 18.

By executing the above-described processes, the encoding device 400 makes it possible to select optimal prediction values from among prediction values of normal vectors derived through various methods. Accordingly, the encoding device 400 makes it possible to suppress deterioration in prediction efficiency.

Therefore, the encoding device 400 makes it possible to suppress deterioration in encoding efficiency.

### <Decoding Device>

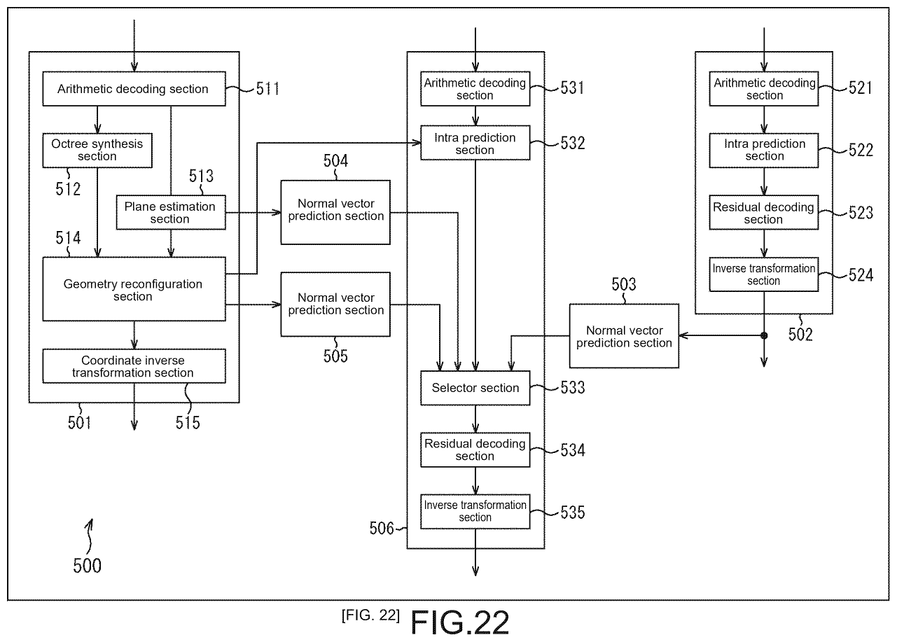

FIG. 22 is a block diagram illustrating an example of a configuration of a decoding device as an aspect of an information processing device to which the present technology is applied. A decoding device 500 illustrated in FIG. 22 is a device that decodes encoded data (bitstream) of a point cloud. The decoding device 500 decodes a bitstream through the GPCC described in Non-Patent Literature 1 to generate (restore) the point cloud. In addition, the decoding device 500 applies the above-described method 1-4 to decode the encoded data of ((prediction residuals of) normal vectors serving as) attributes of the point cloud. For example, the decoding device 500 decodes the bitstream generated by the encoding device 400 (FIG. 17).

Note that, FIG. 22 merely illustrates principal ones among processing sections, data flows, and the like, and does not illustrate all of them. That is, with regard to the decoding device 500, there may be a processing section not illustrated as a block in FIG. 22, or there may be a flow of processing or data not illustrated as an arrow or the like in FIG. 22.

As illustrated in FIG. 22, the decoding device 500 includes a geometry encoding section 501, an attribute decoding section 502, a normal vector prediction section 503, a normal vector prediction section 504, a normal vector prediction section 505, and a normal vector decoding section 506.

In addition, the geometry decoding section 501 includes an arithmetic decoding section 511, an octree synthesis section 512, a plane estimation section 513, a geometry reconfiguration section 514, and a coordinate inverse transformation section 515. In addition, the attribute decoding section 502 includes an arithmetic decoding section 521, an intra prediction section 522, a residual decoding section 523, and an inverse transformation section 524. In addition, the normal vector decoding section 506 includes an arithmetic decoding section 531, an intra prediction section 532, a selector section 533, a residual decoding section 534, and an inverse transformation section 535.

The geometry decoding section 501 performs a process similar to the geometry decoding section 121 (FIG. 6 and FIG. 11). Note that, the geometry decoding section 501 is assumed to decode encoded data of geometries by applying the trisoup.

The arithmetic decoding section 511 of the geometry decoding section 501 acquires the encoded data of geometries and performs arithmetic decoding on the encoded data. The arithmetic decoding section 511 supplies the octree synthesis section 512 with an octree of the geometries obtained through the decoding. The arithmetic decoding section 511 also supplies the plane estimation section 513 with information related to plane estimation obtained through the decoding.

The octree synthesis section 512 transforms the octree and generates voxel data (quantized geometries). The octree synthesis section 512 supplies the generated voxel data to the geometry reconfiguration section 514. In addition, the plane estimation section 513 estimates planes through the trisoup (estimates triangular faces to obtain geometries at lower levels (higher resolution) than the octree). In addition, the plane estimation section 513 disposes points on the estimated planes and generates geometries at the lower levels (higher resolution) than levels expressed by the octree. The plane estimation section 513 supplies the generated geometries to the geometry reconfiguration section 514. The plane estimation section 513 also supplies information indicating the estimated planes to the normal vector prediction section 504.

The geometry reconfiguration section 514 acquires the voxel data supplied from the octree synthesis section 512. The geometry reconfiguration section 514 also acquires geometries at the lower levels supplied from the plane estimation section 513. The geometry reconfiguration section 514 reconfigures the geometries by using these information. This makes it possible to obtain geometries with compression distortion. The geometry reconfiguration section 514 supplies the obtained geometries (geometries with compression distortion) to the coordinate inverse transformation section 515. The geometry reconfiguration section 514 also supplies the geometries to the intra prediction section 522 and the intra prediction section 532. In addition, the geometry reconfiguration section 514 also supplies the geometries to the normal vector prediction section 505.

As necessary, the coordinate inverse transformation section 515 transforms a coordinate system of the geometries supplied from the geometry reconfiguration section 514. In other words, the coordinate inverse transformation section 515 performs an inverse process of coordinate transformation by the coordinate transformation section 411. For example, the coordinate inverse transformation section 515 may transform geometries in an xyz coordinate system into a polar coordinate system. The coordinate inverse transformation section 515 outputs geometries in a coordinate system that has been transformed appropriately.

The attribute decoding section 502 performs a process similar to the attribute decoding section 321 (FIG. 15). The arithmetic decoding section 521 of the attribute decoding section 502 acquires encoded data of (prediction residuals of) attributes other than normal vectors, and performs arithmetic decoding on the encoded data. The arithmetic decoding section 521 supplies the intra prediction section 522 with the prediction residuals of the attributes other than the normal vectors obtained through the decoding.

The intra prediction section 522 acquires the prediction residuals supplied from the arithmetic decoding section 521. The intra prediction section 522 also acquires geometries that have compression distortion and that are supplied from the geometry reconfiguration section 514. Note that, arrows indicating such data movement are omitted in FIG. 22 for ease of explanation. The intra prediction section 522 predicts (performs intra prediction on) attributes other than the normal vector corresponding to a processing target point on the basis of attributes of adjacent points. The intra prediction section 522 supplies the residual decoding section 523 with the prediction residuals and prediction values of the attributes other than the normal vectors obtained through the prediction.

The residual decoding section 523 derives the attributes other than the normal vectors by adding the supplied prediction values to the supplied prediction residuals. The residual encoding section 424 supplies the derived attributes other than the normal vectors to the inverse transformation section 524.

The inverse transformation section 524 performs inverse transformation on the supplied attributes other than the normal vectors as necessary. In other words, the inverse transformation section 524 performs an inverse process of transformation by the transformation section 421. The inverse transformation section 524 outputs the attributes other than the normal vectors subjected to the inverse transformation as necessary. The inverse transformation section 524 also supplies the attributes other than the normal vectors to the normal vector prediction section 503.

The normal vector prediction section 503 performs a process similar to the normal vector prediction section 122 (FIG. 15). For example, the normal vector prediction section 503 predicts the normal vectors on the basis of the attributes other than the normal vectors supplied from the inverse transformation section 524, and derives prediction values of the normal vectors. For example, the normal vector prediction section 503 may derive the prediction values of the normal vectors on the basis of the reflectance. Alternatively, the normal vector prediction section 503 may derive the prediction values of the normal vectors on the basis of the reflection model. Alternatively, the normal vector prediction section 503 may derive the prediction values of the normal vectors by inputting the captured image into the neural network. The normal vector prediction section 503 supplies the derived prediction values to the selector section 533.

The normal vector prediction section 504 performs a process similar to the normal vector prediction section 122 (FIG. 11). For example, the normal vector prediction section 505 predicts the normal vectors on the basis of the “information to be used for encoding geometries” (in this case, information indicating estimated planes) supplied from the plane estimation section 513, and derives prediction values of the normal vectors. Note that, it is possible for the normal vector prediction section 504 to predict the normal vectors on the basis of information other than the information indicating estimated planes, and derive prediction values of the normal vectors, as long as the information is information to be used for encoding geometries. For example, the normal vector prediction section 504 may predict the normal vectors on the basis of the adjacent dot distribution map. Alternatively, the normal vector prediction section 504 may predict the normal vectors on the basis of the table information (LookaheadTable) based on the octree structure. The normal vector prediction section 504 supplies the derived prediction values to the selector section 533.

The normal vector prediction section 505 performs a process similar to the normal vector prediction section 122 (FIG. 6). For example, the normal vector prediction section 505 predicts the normal vectors on the basis of the geometries with compression distortion supplied from the geometry reconfiguration section 514, and derives prediction values of the normal vectors. The normal vector prediction section 505 supplies the derived prediction values to the selector section 533.

The normal vector decoding section 506 performs a process similar to the attribute decoding section 123 (FIG. 6, FIG. 11, and FIG. 15). The arithmetic decoding section 531 of the normal vector decoding section 506 acquires encoded data of (prediction residuals of) normal vectors, and performs arithmetic decoding on the encoded data. The arithmetic decoding section 531 supplies the intra prediction section 532 with the prediction residuals of the normal vectors obtained through the decoding.

The intra prediction section 532 acquires the prediction residuals supplied from the arithmetic decoding section 531. The intra prediction section 532 also acquires geometries that have compression distortion and that are supplied from the geometry reconfiguration section 514. The intra prediction section 532 predicts (performs intra prediction on) the normal vector corresponding to the processing target point on the basis of normal vectors of points adjacent to the processing target point. The intra prediction section 532 supplies the selector section 533 with the prediction residuals and prediction values of the normal vectors obtained through the prediction.

The selector section 533 acquires prediction values supplied from the normal vector prediction section 503 (prediction values derived on the basis of the attributes other than the normal vectors), prediction values supplied from the normal vector prediction section 505 (prediction values derived on the basis of geometries with compression distortion), prediction values supplied from the normal vector prediction section 504 (prediction values derived on the basis of information to be used for encoding geometries), and prediction values supplied from the intra prediction section 532 (prediction values derived through intra prediction of normal vectors). The selector section 533 selects prediction values to be applied from among these prediction values. In other words, the selector section 533 selects prediction values to be applied from among prediction values derived on the basis of the information other than the normal vectors and prediction values derived on the basis of the normal vectors. That is, the selector section 533 selects prediction values to be used from among the plurality of prediction values derived through different methods.

For example, the arithmetic decoding section 531 decodes encoded data of flag information indicating results of selection of prediction values made at a time of encoding, and obtains the flag information. The flag information is included in the bitstream. The selector section 533 may select prediction values on the basis of the flag information transmitted from the encoding side. The selector section 533 supplies the residual decoding section 534 with the normal vectors and the selected prediction values corresponding to the normal vectors.

The residual decoding section 534 derives the normal vectors by adding the supplied prediction values to the supplied prediction residuals. In other words, the residual decoding section 534 adds, to the prediction residuals, the prediction values that are selected by the selector section 533 and that correspond to the prediction residuals, and generates normal vectors. In other words, the residual decoding section 534 generates a normal vector by adding, to a prediction residual, at least one of a prediction value derived by any of the normal vector prediction sections 503 to 505 or a prediction value derived by the intra prediction section 532. The residual decoding section 534 supplies the derived normal vector to the inverse transformation section 535.

The inverse transformation section 535 performs inverse transformation on the supplied normal vectors as necessary. In other words, the inverse transformation section 535 performs an inverse process of transformation by the transformation section 431. The inverse transformation section 535 outputs the normal vectors subjected to the inverse transformation as necessary.

Note that, it is also possible for a combining section (not illustrated) to combine geometries output from the coordinate inverse transformation section 515, attributes other than normal vectors output from the inverse transformation section 524, and normal vectors output from the inverse transformation section 535, and generate data (3D data) of the point cloud including them.

The decoding device 500 including such structural elements makes it possible to select optimal prediction values from among prediction values of normal vectors derived through various methods. Accordingly, the decoding device 500 makes it possible to suppress deterioration in prediction efficiency. Therefore, the decoding device 500 makes it possible to suppress deterioration in encoding efficiency.

### <Flow of Decoding Process>

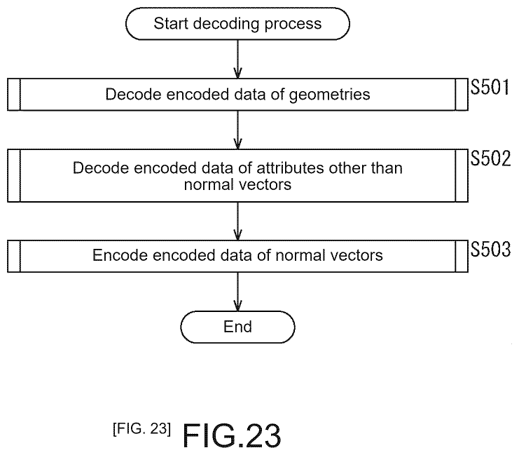

With reference to a flowchart illustrated in FIG. 23, an example of a flow of the decoding process executed by the decoding device 500 will be described.

When the decoding process starts, the geometry decoding section 501 of the decoding device 500 executes a geometry decoding process to decode encoded data of geometries in Step S501.

In Step S502, the attribute decoding section 502 executes an attribute decoding process to decode encoded data of attributes other than normal vectors.

In Step S503, the normal vector prediction sections 503 to 505 and the normal vector decoding section 506 execute a normal vector decoding process to decode the encoded data of the normal vectors.

When the process in Step S503 ends, the decoding process ends.

### <Flow of Geometry Decoding Process>

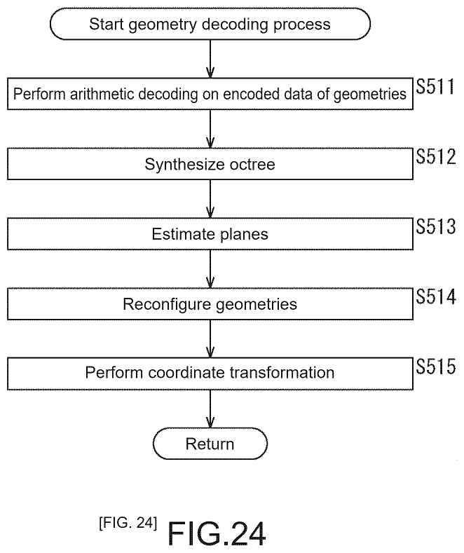

Next, with reference to a flowchart illustrated in FIG. 24, an example of a flow of the geometry decoding process executed in Step S501 of FIG. 23 will be described.

When the geometry decoding process starts, the arithmetic decoding section 511 of the geometry decoding section 501 performs arithmetic decoding on encoded data of geometries in Step S511.

In Step S512, the octree synthesis section 512 synthesizes an octree of the geometries obtained through the process in Step S511, and transforms it into voxel data.

In Step S513, the plane estimation section 513 estimates planes through the trisoup (estimates triangular faces to obtain geometries at lower levels (higher resolution) than the octree).

In Step S514, the geometry reconfiguration section 514 reconfigures the geometries on the basis of the voxel data obtained through the process in Step S512 and the planes estimated through the process in Step S513.

In Step S515, the coordinate inverse transformation section 515 performs inverse transformation on a coordinate system of the reconfigurated geometries as necessary.

When the process in Step S515 ends, the geometry decoding process ends, and the process returns to FIG. 23.

### <Flow of Attribute Decoding Process>

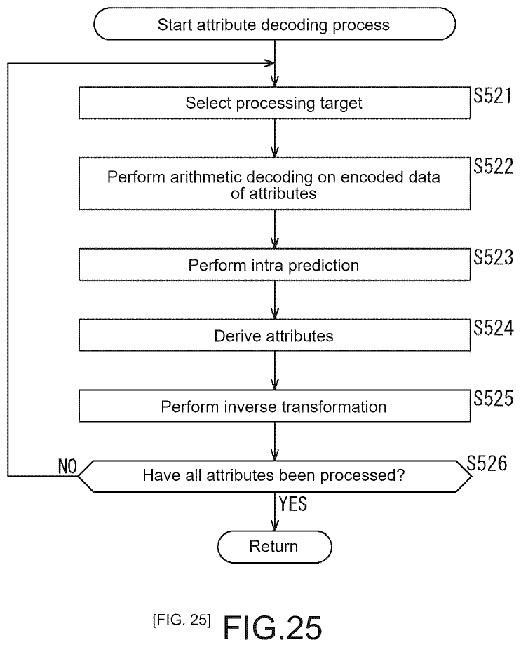

Next, with reference to a flowchart illustrated in FIG. 25, an example of a flow of the attribute decoding process executed in Step S502 of FIG. 23 will be described.

When the attribute decoding process starts, the arithmetic decoding section 521 of the attribute decoding section 411 selects a processing target point in Step S521.

In Step S522, the arithmetic decoding section 521 performs arithmetic decoding on encoded data of attributes other than a normal vector corresponding to the selected processing target point, and obtains prediction residuals of the attributes other than the normal vector corresponding to the processing target point.

In Step S523, the intra prediction section 522 predicts (performs intra prediction on) the attributes other than the normal vector corresponding to the processing target point on the basis of attributes of adjacent points.

In Step S524, the residual decoding section 523 derives the attributes other than the normal vector corresponding to the processing target point, by adding prediction values obtained through the process in Step S523 to the prediction residuals obtained through the process in Step S522.

In Step S525, the inverse transformation section 524 performs inverse transformation on the attributes other than the normal vector derived through the process in Step S524, as necessary.

In Step S526, the inverse transformation section 524 determines whether or not attributes other than the normal vector have been processed with regard to all the points. In a case where it is determined that there remains an unprocessed attribute, the process returns to Step S521 and selects a new processing target. In other words, the attributes other than the normal vectors are derived by executing the respective processes in Steps S521 to S526 with regard to each of the points.

Next, in a case where it is determined that all the attributes have been processed in Step S526, the attribute decoding process ends and the process returns to FIG. 23.

### <Flow of Normal Vector Decoding Process>

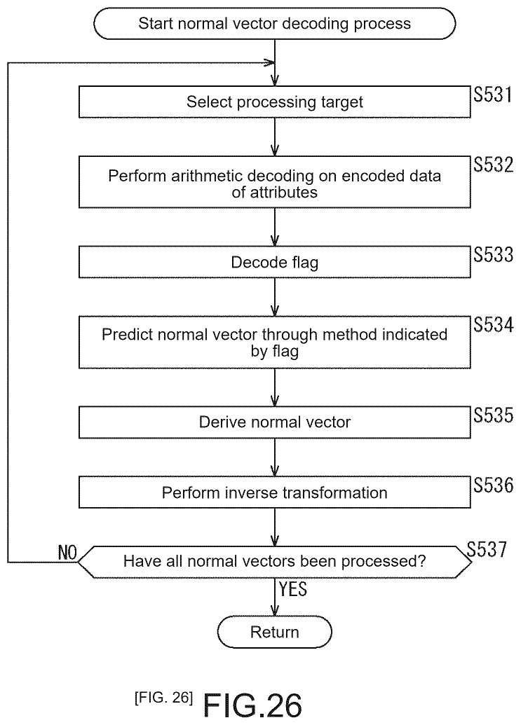

Next, with reference to a flowchart illustrated in FIG. 26, an example of a flow of the normal vector decoding process executed in Step S503 of FIG. 23 will be described.

When the attribute decoding process starts, the arithmetic decoding section 531 of the normal vector decoding section 506 selects a processing target point in Step S531.

In Step S532, the arithmetic decoding section 531 performs arithmetic decoding on encoded data of a normal vector corresponding to the selected processing target point, and obtains a prediction residual of the normal vector corresponding to the processing target point.

In Step S533, the arithmetic decoding section 531 decodes encoded data of flag information indicating a result of selection of a prediction value derivation method.

In Step S534, the selector section 533 selects a method indicated by the flag information for predicting the normal vector corresponding to the processing target point. In other words, under the control of the selector section 533, among the normal vector prediction sections 503 to 505 and the intra prediction section 532, a processing section designated by the flag information predicts the normal vector corresponding to the processing target point. For example, in a case where the normal vector prediction section 503 is selected by the flag information, the normal vector prediction section 503 predicts the normal vector corresponding to the processing target point on the basis of the attributes other than the normal vector. Alternatively, in a case where the normal vector prediction section 504 is selected by the flag information, the normal vector prediction section 504 predicts the normal vector corresponding to the processing target point on the basis of the information to be used for decoding geometries. Alternatively, in a case where the normal vector prediction section 505 is selected by the flag information, the normal vector prediction section 505 predicts the normal vector corresponding to the processing target point on the basis of the geometries with compression distortion. Alternatively, in a case where the intra prediction section 532 is selected by the flag information, the intra prediction section 532 predicts (performs intra prediction on) the normal vector corresponding to the processing target point on the basis of normal vectors of adjacent points.

In Step S535, the residual decoding section 534 derives the normal vector corresponding to the processing target point, by adding prediction value obtained through the process in Step S534 to the prediction residual obtained through the process in Step S532.

In Step S536, the inverse transformation section 535 performs inverse transformation on the normal vector derived through the process in Step S535, as necessary.

In Step S537, the inverse transformation section 535 determines whether or not the normal vectors have been processed with regard to all the points. In a case where it is determined that there remains an unprocessed normal vector, the process returns to Step S531 and selects a new processing target. In other words, the normal vectors are derived by executing the respective processes in Steps S531 to S537 with regard to each of the points.

Next, in a case where it is determined that all the normal vectors have been processed in Step S537, the normal vector decoding process ends and the process returns to FIG. 23.

By executing the above-described processes, the decoding device 500 makes it possible to select optimal prediction values from among prediction values of normal vectors derived through various methods. Accordingly, the decoding device 500 makes it possible to suppress deterioration in prediction efficiency. Therefore, the decoding device 500 makes it possible to suppress deterioration in encoding efficiency.

### <Method 1-4-2>

Note that, when using the method 1-4-1, a prediction value to be applied is selected from among a plurality of prediction values of the normal vector derived through different methods. However, it is also possible to generate the prediction value to be applied by combining the plurality of prediction values. In other words, in a case where the above-described method 1-4 is applied, a plurality of prediction results obtained through different methods may be combined as illustrated in a bottom row of the table in FIG. 2 (method 1-4-2).

For example, in the case where the above-described information processing device includes the normal vector prediction section, the prediction residual generation section, the prediction residual encoding section, and the intra prediction section, the prediction residual generation section may generates a prediction residual by using a result of combining a plurality of prediction values derived through different methods. For example, the prediction residual generation section may generate the prediction residual by using a result of combining a prediction value and a second prediction value.

In this case, for example, the encoding device 400 (FIG. 17) may include a combining section configured to combine a plurality of prediction results obtained through different methods, instead of the selector section 434.

In addition, for example, in the case where the above-described information processing device includes the normal vector prediction section, the normal vector decoding section, and the intra prediction section, the normal vector decoding section may derive an yet-to-be-encoded normal vector of an encoding target point by adding the plurality of prediction results obtained through different methods to a prediction residual. For example, the normal vector decoding section may derive the yet-to-be-encoded normal vector of the encoding target point by adding a result of combining a prediction value and a second prediction value to a prediction residual.

In this case, for example, the decoding device 500 (FIG. 22) may include a combining section configured to combine a plurality of prediction results obtained through different methods, instead of the selector section 533.

This allows the information processing device to suppress deterioration in encoding efficiency.

### <Inter Prediction>

With regard to the method 1-4 and subsequent methods, the intra prediction has been performed. However, instead of the intra prediction, it is also possible to perform inter prediction of predicting a normal vector of a processing target frame by using normal vectors of other frames. Alternatively, the intra prediction may be used in conjunction with the inter prediction. This allows the information processing device to suppress deterioration in encoding efficiency.

### 4. Supplementary Notes

### <Computer>

The series of processes described above can be executed by hardware or software. In a case where the series of processes is executed by software, a program configuring the software is installed on a computer. Here, the computer includes, for example, a computer incorporated in dedicated hardware, a general-purpose personal computer capable of executing various functions by installing various programs, and the like.

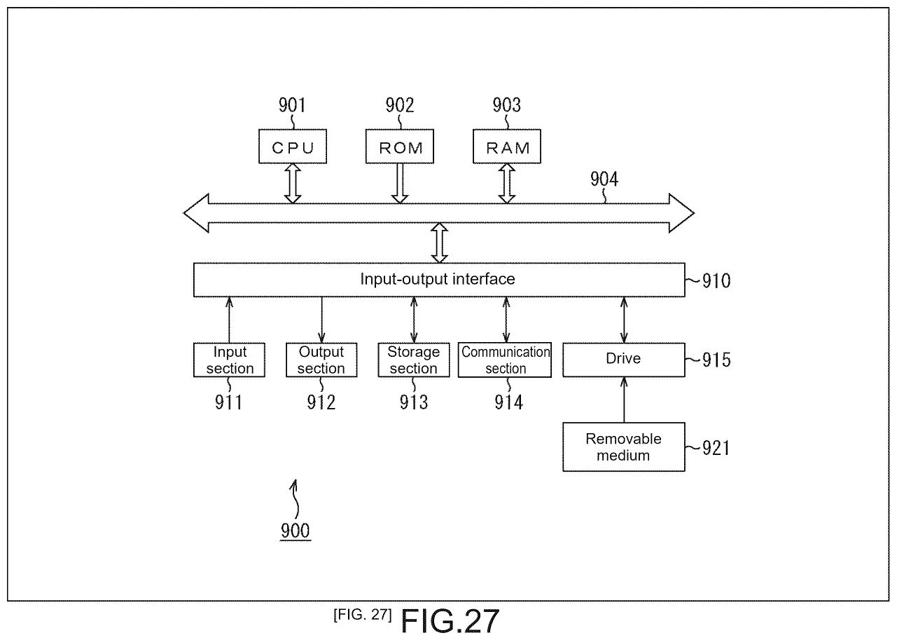

FIG. 27 is a block diagram illustrating a configuration example of hardware of a computer that executes the series of processes described above by means of a program.

In a computer 900 illustrated in FIG. 27, a central processing unit (CPU) 901, a read only memory (ROM) 902, and a random access memory (RAM) 903 are coupled to each other via a bus 904.

The bus 904 is also coupled to an input-output interface 910. The input-output interface 910 is also coupled to an input section 911, an output section 912, a storage section 913, a communication section 914, and a drive 915.

The input section 911 includes, for example, a keyboard, a mouse, a microphone, a touchscreen, an input terminal, and the like. The output section 912 includes, for example, a display, a speaker, an output terminal, and the like. The storage section 913 includes, for example, a hard disk, a RAM disk, a non-volatile memory, and the like. The communication section 914 includes, for example, a network interface. The drive 915 drives a removable medium 921, such as a magnetic disk, an optical disc, a magneto-optical disc, or a semiconductor memory.

In the computer configured as described above, for example, the CPU 901 loads a program stored in the storage section 913 into the RAM 903 via the input-output interface 910 and the bus 904, and executes the program, thereby performing the series of processes described above. The RAM 903 also stores, as appropriate, data and the like required for the CPU901 to execute various processes.

Programs to be executed by the computer can be recorded on the removable medium 921 as a package medium or the like, for example, and applied. In this case, the program can be installed on the storage section 913 via the input-output interface 910 by mounting the removable medium 921 on the drive 915.

Further, the program may also be provided via a wired or wireless transmission medium, such as a local area network, the Internet, or digital satellite broadcasting. In that case, the program can be received by the communication section 914 and installed on the storage section 913.

Alternatively, the program can be installed in advance on the ROM 902, the storage section 913, or the like.

<Targets to which Present Technology is Applied>

The present technology can be applied to any appropriate configuration. For example, the present technology may be applied to various electronic apparatuses.

Further, for example, the present technology can also be embodied as a component of an apparatus, such as a processor (a video processor, for example) serving as a system large-scale integration (LSI) or the like, a module (a video module, for example) using a plurality of processors or the like, a unit (a video unit, for example) using a plurality of modules or the like, or a set (a video set, for example) having other functions added to units.

Further, for example, the present technology can also be applied to a network system including a plurality of devices, for example. For example, the present technology may be embodied as cloud computing that is shared and jointly processed by a plurality of devices via a network. For example, the present technology may be embodied in a cloud service that provides services related to images (video images) to any kinds of terminals such as computers, audio visual (AV) devices, portable information processing terminals, and IoT (Internet of things) devices.

Note that, in the present specification, a system means an assembly of plurality of components (devices, modules (parts), and the like), and not all the components need to be provided in the same housing. In view of this, a plurality of devices that are housed in different housings and are connected to one another via a network forms a system, and one device having plurality of modules housed in one housing is also a system.

<Fields and Usage to which Present Technology Can be Applied>

A system, a device, a processing section, and the like to which the present technology is applied can be used in any appropriate field such as transportation, medical care, crime prevention, agriculture, livestock industry, mining, beauty care, factories, household appliances, meteorology, or nature observation, for example. Further, the present technology can also be used for any appropriate purpose.

### Other Aspects

Note that, in this specification, a “flag” is information for identifying a plurality of states, and includes not only information to be used for identifying two states of true (1) or false (0), but also information for identifying three or more states. Therefore, the values this “flag” can have may be the two values of “1” and “0”, for example, or three or more values. That is, this “flag” may be formed with any number of bits, and may be formed with one bit or a plurality of bits. Further, as for identification information (including a flag), not only the identification information but also difference information about the identification information with respect to reference information may be included in a bitstream. Therefore, in this specification, a “flag” and “identification information” include not only the information but also difference information with respect to the reference information.

Further, various kinds of information (such as metadata) regarding encoded data (bitstream) may be transmitted or recorded in any mode that is associated with the encoded data. Here, the term “to associate” means to enable use of one data (or a link to other data) while other data is processed, for example. That is, pieces of data associated with each other may be integrated as one piece of data, or may be regarded as separate pieces of data. For example, information associated with encoded data (image) may be transmitted through a transmission path different from the encoded data (image). Further, information associated with encoded data (image) may be recorded in a recording medium different from the encoded data (image) (or in a different recording area of the same recording medium), for example. Note that this “association” may apply to some of the data, instead of the entire data. For example, an image and the information corresponding to the image may be associated with each other in any appropriate unit, such as a plurality of frames, each frame, or some portion in each frame.

Note that, in this specification, the terms “to combine”, “to multiplex”, “to add”, “to integrate”, “to include”, “to store”, “to contain”, “to incorporate, “to insert”, and the like mean combining a plurality of objects into one, such as combining encoded data and metadata into one piece of data, for example, and mean methods of the above described “association”.

Further, embodiments of the present technology are not limited to the above described embodiments, and various modifications may be made to them without departing from the scope of the present technology.

For example, any configuration described above as one device (or one processing section) may be divided into a plurality of devices (or processing sections). Conversely, any configuration described above as a plurality of devices (or processing sections) may be combined into one device (or one processing section). Furthermore, it is of course possible to add a component other than those described above to the configuration of each device (or each processing section). Further, some components of a device (or processing section) may be incorporated into the configuration of another device (or processing section) as long as the configuration and the functions of the entire system remain substantially the same.

Also, the program described above may be executed in any device, for example. In that case, it is sufficient for the device to have necessary functions (function blocks and the like) so that necessary information can be obtained.

Also, a single device may carry out respective steps in one flowchart, or a plurality of devices may carry out the respective steps, for example. Further, in a case where a single step includes a plurality of processes, the plurality of processes may be performed by a single device or may be performed by a plurality of devices. In other words, a plurality of processes included in a single step may be performed as processes in a plurality of steps. Conversely, processes described as a plurality of steps may be collectively performed as a single step.

Also, a program to be executed by a computer may be a program for performing the processes in the steps according to the program in chronological order in accordance with the sequence described in this specification, or may be a program for performing processes in parallel or performing a process when necessary, such as when there is a call, for example. That is, as long as there are no contradictions, the processes in the respective steps may be performed in a different order from the above described order. Further, the processes in the steps according to this program may be executed in parallel with the processes according to another program, or may be executed in combination with the processes according to another program.

Also, each of the plurality of techniques according to the present technology can be independently implemented, as long as there are no contradictions, for example. It is of course also possible to implement a combination of some of the plurality of techniques according to the present technology. For example, part or all of the present technology described in one of the embodiments may be implemented in combination with part or all of the present technology described in another one of the embodiments. Further, part or all of the present technology described above may be implemented in combination with some other technology not described above.

Note that, the present technology may also be configured as below.

(1)

An information processing device including:
a normal vector prediction section configured to predict a yet-to-be-encoded normal vector of an encoding target point on the basis of encoded information different from the yet-to-be-encoded normal vector obtained through an encoding process of point cloud data, and derive a prediction value of the yet-to-be-encoded normal vector, in the encoding process;
a prediction residual generation section configured to generate a prediction residual that is a difference between the prediction value and the yet-to-be-encoded normal vector; and
a prediction residual encoding section configured to encode the prediction residual.
   (2)

The information processing device according to (1), further including:
a geometry encoding section configured to encode a geometry of the point cloud data as the encoded information; and
a geometry decoding section configured to decode the geometry that has been encoded,
in which the normal vector prediction section derives the prediction value on the basis of the geometry that has been decoded.
   (3)

The information processing device according to (1) or (2), further including
a geometry encoding section configured to encode a geometry of the point cloud data as the encoded information,
in which the normal vector prediction section derives the prediction value on the basis of analysis of an octree of the geometry that has been encoded.
   (4)

The information processing device according to (3), in which
the normal vector prediction section derives the prediction value on the basis of map information indicating a point adjacent to the encoding target point in the octree structure.
   (5)

The information processing device according to (3) or (4), in which
the normal vector prediction section derives the prediction value on the basis of table information based on the octree structure.
   (6)

The information processing device according to any of (3) to (5), in which
the normal vector prediction section sets, as the prediction value, a normal of a triangular face of the geometry that has been encoded at a level of the octree having predetermined resolution, and
the triangular face of the geometry is a face to be subjected to a trisoup decoding process at a time of decoding.
   (7)

The information processing device according to any of (1) to (6), further including:
an attribute encoding section configured to encode an attribute of the point cloud data as the encoded information; and
an attribute decoding section configured to decode the attribute that has been encoded,
in which the normal vector prediction section derives the prediction value on the basis of the attribute that has been decoded.
   (8)

The information processing device according to (7), in which
the attribute that has been decoded includes information related to reflectance, and
the normal vector prediction section derives the prediction value on the basis of the reflectance.
   (9)

The information processing device according to (7) or (8), in which
the attribute that has been decoded includes information related to a reflection model of light, and
the normal vector prediction section derives the prediction value on the basis of the reflection model.
   (10)

The information processing device according to any of (7) to (9), in which
the normal vector prediction section derives the prediction value by using a neural network that outputs the prediction value on the basis of a captured image.
   (11)

The information processing device according to any of (1) to (10), further including
a selector section configured to select at least one of a plurality of the prediction values,
in which the normal vector prediction section derives a prediction value based on a geometry of the point cloud data and a prediction value based on an attribute of the point cloud data, as the plurality of prediction values.
   (12)

The information processing device according to any of (1) to (11), further including:
an intra prediction section configured to derive a second prediction value of the yet-to-be-encoded normal vector through intra prediction based on a normal vector of a point adjacent to the encoding target point; and
a selector section configured to select at least one of the prediction value or the second prediction value,
in which the prediction residual generation section generates the prediction residual on the basis of at least one of the prediction value or the second prediction value.
   (13)

The information processing device according to (12), in which
the selector section sets a flag indicating a result of the selection, and
the prediction residual encoding section encodes the flag.
   (14)

The information processing device according to (12) or (13), in which
the prediction residual generation section generates the prediction residual by using a result of combining the prediction value and the second prediction value.
   (15)

An information processing method including:
predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process;
generating a prediction residual that is a difference between the prediction value and the yet-to-be-encoded normal vector; and
encoding the prediction residual.
   (21)

An information processing device including:
a normal vector prediction section configured to predict a yet-to-be-encoded normal vector of an encoding target point on the basis of encoded information different from the yet-to-be-encoded normal vector obtained through an encoding process of point cloud data, and derive a prediction value of the yet-to-be-encoded normal vector, in the encoding process; and
a normal vector decoding section configured to derive the yet-to-be-encoded normal vector by decoding a prediction residual that has been encoded and adding the prediction value to the prediction residual.
   (22)

The information processing device according to (21), further including
a geometry decoding section configured to decode a geometry of the point cloud data that has been encoded as the encoded information,
in which the normal vector prediction section derives the prediction value on the basis of the geometry that has been decoded.
   (23)

The information processing device according to (21) or (22), further including
a geometry decoding section configured to decode a geometry of the point cloud data that has been encoded as the encoded information,
in which the normal vector prediction section derives the prediction value on the basis of analysis of an octree of the geometry.
   (24)

The information processing device according to (23), in which
the normal vector prediction section derives the prediction value on the basis of map information indicating a point adjacent to the encoding target point in the octree structure.
   (25)

The information processing device according to (23) or (24), in which
the normal vector prediction section derives the prediction value on the basis of table information based on the octree structure.
   (26)

The information processing device according to any of (23) to (25), in which
the normal vector prediction section sets, as the prediction value, a normal of a triangular face of the geometry that has been encoded at a level of the octree having predetermined resolution, and
the triangular face of the geometry is a face to be subjected to a trisoup decoding process at a time of decoding.
   (27)

The information processing device according to any of (21) to (26) further including
an attribute decoding section configured to decode an attribute of the point cloud data that has been encoded as the encoded information,
in which the normal vector prediction section derives the prediction value on the basis of the attribute that has been decoded.
   (28)

The information processing device according to (27), in which
the attribute that has been decoded includes information related to reflectance, and
the normal vector prediction section derives the prediction value on the basis of the reflectance.
   (29)

The information processing device according to (27) or (28), in which
the attribute that has been decoded includes information related to a reflection model of light, and
the normal vector prediction section derives the prediction value on the basis of the reflection model.
   (30)

The information processing device according to any of (27) to (29), in which
the normal vector prediction section derives the prediction value by using a neural network that outputs the prediction value on the basis of a captured image.
   (31)

The information processing device according to any of (21) to (30), further including
a selector section configured to select at least one of a plurality of the prediction values,
in which the normal vector prediction section derives a prediction value based on a geometry of the point cloud data and a prediction value based on an attribute of the point cloud data, as the plurality of prediction values.
   (32)

The information processing device according to any of (21) to (31), further including:
an intra prediction section configured to derive a second prediction value of the yet-to-be-encoded normal vector through intra prediction based on a normal vector of the point adjacent to the encoding target point; and
a selector section configured to select at least one of the prediction value or the second prediction value,
in which, the normal vector decoding section derives the yet-to-be-encoded normal vector by adding at least one of the prediction value or the second prediction value to the prediction residual.
   (33)

The information processing device according to (32), in which
the selector section selects a prediction value on the basis of a flag indicating a prediction value derivation method applied at a time of encoding.
   (34)

The information processing device according to (32) or (33), in which
the normal vector decoding section derives the yet-to-be-encoded normal vector by adding a result of combining the prediction value and the second prediction value to the prediction residual.
   (35)

An information processing method including:
predicting a yet-to-be-encoded normal vector of an encoding target point on the basis of encoded information different from the yet-to-be-encoded normal vector obtained through an encoding process of point cloud data, and deriving a prediction value of the yet-to-be-encoded normal vector, in the encoding process; and
deriving the yet-to-be-encoded normal vector by decoding a prediction residual that has been encoded and adding the prediction value to the prediction residual.

### REFERENCE SIGNS LIST

100 encoding device
101 geometry encoding section
102 geometry decoding section
103 normal vector prediction section
104 prediction residual generation section
105 attribute encoding section
106 combining section
120 decoding device
121 geometry decoding section
122 normal vector prediction section
123 attribute decoding section
124 combining section
200 encoding device
220 decoding device
300 encoding device
301 attribute encoding section
302 attribute decoding section
320 decoding device
321 attribute decoding section
400 encoding device
401 geometry encoding section
402 geometry reconfiguration section
403 attribute encoding section
404 decoding section
405 to 407 normal vector prediction section
408 normal vector encoding section
411 coordinate transformation section
412 quantizer section
413 octree analysis section
414 plane estimation section
415 arithmetic encoding section
421 transformation section
422 recoloring process section
423 intra prediction section
424 residual encoding section
425 arithmetic encoding section
431 transformation section
432 recoloring process section
433 intra prediction section
434 selector section
435 residual encoding section
436 arithmetic encoding section
500 decoding device
501 geometry encoding section
502 attribute decoding section
503 to 505 normal vector prediction section
506 normal vector decoding section
511 arithmetic decoding section
512 octree synthesis section
513 plane estimation section
514 geometry reconfiguration section
515 coordinate inverse transformation section
521 arithmetic decoding section
522 intra prediction section
523 residual decoding section
524 inverse transformation section
531 arithmetic decoding section
532 intra prediction section
533 selector section
534 residual decoding section
535 inverse transformation section
900 computer

1. An information processing device comprising:
a normal vector prediction section configured to predict a yet-to-be-encoded normal vector of an encoding target point on a basis of encoded information different from the yet-to-be-encoded normal vector obtained through an encoding process of point cloud data, and derive a prediction value of the yet-to-be-encoded normal vector, in the encoding process;
a prediction residual generation section configured to generate a prediction residual that is a difference between the prediction value and the yet-to-be-encoded normal vector; and
a prediction residual encoding section configured to encode the prediction residual.

2. The information processing device according to claim 1, further comprising:
a geometry encoding section configured to encode a geometry of the point cloud data as the encoded information; and
a geometry decoding section configured to decode the geometry that has been encoded,
wherein the normal vector prediction section derives the prediction value on a basis of the geometry that has been decoded.

3. The information processing device according to claim 1, further comprising
a geometry encoding section configured to encode a geometry of the point cloud data as the encoded information,
wherein the normal vector prediction section derives the prediction value on a basis of analysis of an octree of the geometry that has been encoded.

4. The information processing device according to claim 3, wherein
the normal vector prediction section derives the prediction value on a basis of map information indicating a point adjacent to the encoding target point in the octree structure.

5. The information processing device according to claim 3, wherein
the normal vector prediction section derives the prediction value on a basis of table information based on the octree structure.

6. The information processing device according to claim 3, wherein
the normal vector prediction section sets, as the prediction value, a normal of a triangular face of the geometry that has been encoded at a level of the octree having predetermined resolution, and
the triangular face of the geometry is a face to be subjected to a trisoup decoding process at a time of decoding.

7. The information processing device according to claim 1, further comprising:
an attribute encoding section configured to encode an attribute of the point cloud data as the encoded information; and
an attribute decoding section configured to decode the attribute that has been encoded,
wherein the normal vector prediction section derives the prediction value on a basis of the attribute that has been decoded.

8. The information processing device according to claim 7, wherein
the attribute that has been decoded includes information related to reflectance, and
the normal vector prediction section derives the prediction value on a basis of the reflectance.

9. The information processing device according to claim 7, wherein
the attribute that has been decoded includes information related to a reflection model of light, and
the normal vector prediction section derives the prediction value on a basis of the reflection model.

10. The information processing device according to claim 7, wherein
the normal vector prediction section derives the prediction value by using a neural network that outputs the prediction value on a basis of a captured image.

11. The information processing device according to claim 1, further comprising
a selector section configured to select at least one of a plurality of the prediction values,
wherein the normal vector prediction section derives a prediction value based on a geometry of the point cloud data and a prediction value based on an attribute of the point cloud data, as the plurality of prediction values.

12. The information processing device according to claim 1, further comprising:
an intra prediction section configured to derive a second prediction value of the yet-to-be-encoded normal vector through intra prediction based on a normal vector of a point adjacent to the encoding target point; and
a selector section configured to select at least one of the prediction value or the second prediction value,
wherein the prediction residual generation section generates the prediction residual on a basis of at least one of the prediction value or the second prediction value.

13. The information processing device according to claim 12, wherein
the selector section sets a flag indicating a result of the selection, and
the prediction residual encoding section encodes the flag.

14. The information processing device according to claim 12, wherein
the prediction residual generation section generates the prediction residual by using a result of combining the prediction value and the second prediction value.

15. An information processing method comprising:
predicting a yet-to-be-encoded normal vector of an encoding target point on a basis of encoded information different from the yet-to-be-encoded normal vector obtained through an encoding process of point cloud data, and deriving a prediction value of the yet-to-be-encoded normal vector, in the encoding process;
generating a prediction residual that is a difference between the prediction value and the yet-to-be-encoded normal vector; and
encoding the prediction residual.

16. An information processing device comprising:
a normal vector prediction section configured to predict a yet-to-be-encoded normal vector of an encoding target point on a basis of encoded information different from the yet-to-be-encoded normal vector obtained through an encoding process of point cloud data, and derive a prediction value of the yet-to-be-encoded normal vector, in the encoding process; and
a normal vector decoding section configured to derive the yet-to-be-encoded normal vector by decoding a prediction residual that has been encoded and adding the prediction value to the prediction residual.

17. The information processing device according to claim 16, further comprising
a geometry decoding section configured to decode a geometry of the point cloud data that has been encoded as the encoded information,
wherein the normal vector prediction section derives the prediction value on a basis of the geometry that has been decoded.

18. The information processing device according to claim 16, further comprising
a geometry decoding section configured to decode a geometry of the point cloud data that has been encoded as the encoded information,
wherein the normal vector prediction section derives the prediction value on a basis of analysis of an octree of the geometry.

19. The information processing device according to claim 16, further comprising
an attribute decoding section configured to decode an attribute of the point cloud data that has been encoded as the encoded information,
wherein the normal vector prediction section derives the prediction value on a basis of the attribute that has been decoded.

20. An information processing method comprising:
predicting a yet-to-be-encoded normal vector of an encoding target point on a basis of encoded information different from the yet-to-be-encoded normal vector obtained through an encoding process of point cloud data, and deriving a prediction value of the yet-to-be-encoded normal vector, in the encoding process; and
deriving the yet-to-be-encoded normal vector by decoding a prediction residual that has been encoded and adding the prediction value to the prediction residual.
